(19) United States
(12) Patent Application Publication
(10) Pub. No.: US 2014/0097706 A1
(43) Pub. Date: Apr. 10, 2014

(54) XCL Power Producer

(71) Applicant: Edward Anthony Martinez, Rising Sun, OH (US)

(72) Inventor: Edward Anthony Martinez, Rising Sun, OH (US)

(21) Appl. No.: 13/648,287

(22) Filed: Oct. 10, 2012

(51) Int. Cl. H02K 44/00

(52) U.S. Cl. CPC H02K 44/00; H02K 53/00
USPC 310/11; 74/DIG. 9

(57) ABSTRACT

The XCL Power Producer works by moving molecules to said bodies and continues to move at uniform velocities acted upon vacuum pressures by force, which creates an acceleration of energy production. Produces 45,000 volts @ 300 amps every 4 minutes for a 14 year cycle, continually, as a main power source or back-up system. Clean, renewable, nonradioactive energy with zero emissions and few moving parts, installed at reduced footprints. This innovation of molecular energy has a capacitor, diploid magnetron technology, oscillator and photo cell, producing sign waves typically higher than alternating current technologies today, allowing the power to travel up to 1,891 miles. Due to its conservative use of oil and methane hydrate crystalline, it produces more energy at longer intervals, reducing costs of manufacturing, production, and consumption. Its production of negatively charged ions drives radioactive particulates out of our environment, including the body, within resonance fielding and reduces radiation pressure.

### REFERENCES CITED

U.S. Patent Documents

| | | |
|---|---|---|
| 8,074,704 | Dec. 13, 2011 | Blackburn et al |
| 8,081,851 | Dec. 20, 2011 | Koos et al |
| 8,065,936 | Nov. 29, 2011 | Tutino, John C. |
| 8,058,552 | Nov. 15, 2011 | Kruse et al |
| 8,058,879 | Nov. 15, 2011 | Atherton, John C. |
| 4,438,387 | Mar. 20, 1984 | Rohatin, Frederick |
| 7,868,484 | Jan. 11, 2011 | Groff et al |
| 8,033,511 | Oct. 11, 2011 | Grivas et al |
| 8,074,943 | Dec. 13, 2011 | Boudreau et al |
| 7,849,590 | Dec. 14, 2011 | Mangone, Jr., Peter G. |
| 7,992,728 | Aug. 9, 2011 | Burgess et al |
| 5,929,373 | Jul. 27, 1999 | Schiavo et al |
| 8,082,570 | Dec. 20, 2011 | Olson et al |
| 7,936,298 | May 3, 2011 | Shabra, Ayman |
| 7,989,917 | Aug. 2, 2011 | Klee et al |
| 7,944,365 | May 17, 2011 | Walters et al |
| 7,999,485 | Aug. 16, 2011 | Richards et al |
| 8,061,524 | Nov. 22, 2011 | Camoriano et al |
| 8,081,040 | Dec. 20, 2011 | Avitan, Shimon |
| 8,040,011 | Oct. 18, 2011 | Mueller et al |
| 8,075,825 | Dec. 13, 2011 | Takahashi et al |
| 6,830,626 | Dec. 14, 2004 | Smith, Gary L. |
| 8,076,581 | Dec. 13, 2011 | Schmidt, Angelika |
| 8,080,319 | Dec. 20, 2011 | Tanaka et al |
| 7,585,543 | Sep. 8, 2009 | Leddy et al |
| 8,013,696 | Sep. 6, 2011 | Khetan et al |
| 7,337,156 | Feb. 26, 2008 | Wippich, Heinz-Georg |
| 5,925,862 | Jul. 20, 1999 | Morrisey et al |
| 8,081,505 | Dec. 20, 2011 | Kajiyama et al |
| 8,012,318 | Sep. 6, 2011 | Marsden et al |
| 4,285,914 | Aug. 25, 1981 | Davidson, Charles F. |
| 8,080,597 | Dec. 20, 2011 | Sudhakar, Ashok Em |
| 8,033,251 | Oct. 11, 2011 | Bagnall et al |
| 7,330,094 | Feb. 12, 2008 | McCarthy, Michael Patrick |

### BACKGROUND OF THE INVENTION

Typical power production produces alternating current at wavelengths of 4.14 and lower. Nuclear power can be delineative in that the molecular fallout can affect the radiation pressure of our planet, adversely changing life genetically. Nuclear power has a molecular deluge that creates positron differences through our common grid. It is typical for nuclear power plants to produce H10 particles that run through our common grid and can abrupt transformers and zeal common household appliances. With the inductive power produced by the XCL Power Producer, the sign waves are at 9.418 and higher. Inductive power can purge our common grid of H10 and H9 particles produced by nuclear power plants, and break down these particles before the end user is adversely affected. The XCL Power Producer has the ability to withstand corona mass ejection (CME) by deflecting radioactive particles. Typical solar power requires a wide range of variables, including acres of land, thousands of PV panels, and higher maintenance costs. Solar power, although inductive in nature, only produces 14.8 volts @ 2.3 amps for 2.318 miles per panel, with a maximum inductive ability of 14.8 miles, regardless of the number of panels utilized. Additional solar panels will not increase the overall power production of solar energy. The XCL Power Producer has sign waves at 9.4 over and can produce electricity for longer durations and longer distances, and can travel up to 1,891 miles without delineation or amperage drop. Power can be utilized at its maximum throughout the entire 1,891 miles without any decrease or variation in production, amperage or voltage. At 1,891 miles, exactly, the voltage drops to 3,000 volts @ 28 amps and will convex for 32 additional miles without any other impulse. The generation of wind power, in its conductive ability has drawbacks as well. Most wind power typically produces 1.2 million watts annually; however, the quantity factor (quan factor) in travel is only 48.2 miles, with significant amperage drop at the 46 mile mark. These towers overheat during high winds, and can cause catastrophic failure to the blades and the generator at the top of the tower. There is present danger for birds and wildlife that abrupt the blades. During low wind conditions, power is not being produced and power production deficiencies occur. The XCL Power Producer has a continuous deluge of molecular energy giving baseline energy the sustainability during any and all weather conditions.

In hydro-electric power production, there is a tremendous amount of mechanical and electrical engineering required to maintain a level of energy adequate enough to supply power to the communities they serve. Their diesel-fired generators contribute to greenhouse gases from emissions they release into the atmosphere. The XCL Power Producer is engineered without emissions, thereby producing no greenhouse gasses. The XCL Power Producer utilizes no large turbine generators in energy production, reducing maintenance costs and mechanical and electrical engineering costs due to its small footprint.

Coal energy power production is a large contributor to greenhouse gasses. Their induction rate is at levels that adversely effect our environment. The amount of power required by a coal burning facility in its sequestion of coal can produce billions of particulates that have not been consumed during the firing process, which deluge into the atmosphere creating higher levels of carbon dioxide and the contribution of greenhouse gasses. This adds to the greenhouse effect and depletion of our coal reserves due to their continuous operation. There are many adverse effects of coal energy production, including the contribution of contaminates like coal ash, which cause lung and respiratory diseases, wildlife and bird fatalities, byproducts that interrupt our eco water systems, and the contamination of our fresh water supplies. The XCL Power Producer, in its energy production, has no burn effect, no emissions, no carbon dioxide production, and no byproduct to adversely effect our environment or eco system. This application is the design of inductive power for electrical output in power production systems. The transverse energy is applied with negatively charged ionic pulses at wave lengths 9.418 and higher. The XCL Power Producer emits a resistance of 1.1 hex joules at the resonance field driver assembly that help at balancing the positron infiltration of current technologies. There must be a balance in nature to balance the positron technology currently used. The XCL Power Producer's negatively charged ions create this balance and drive radioactive particulates out of our atmosphere thereby reducing radiation pressure. This is accomplished at the resonance field driver plate by driving the negatively charged ions as a column of energy going upward at 41 degrees into the atmosphere for 200 feet and dissipating on each side for 1,300 miles. The resonance field in this form reduces the electron base in the adapture. Each electron originally manifested is now reduced an additional 1,400 times (smaller). The cellular infraction at this level can be utilized in medical synergy which is similar, but opposite, of radiation treatments today, in a resonance field index or distance from the resonance field driver assembly. The resonance field driver also attracts electrolysis moving through the Earth for 1,300 miles in circumference, which would otherwise be attracted or driven to other steel structures in the community, which could cause the delineation of those steel structures.

The XCL Power Producer works by moving molecules to said bodies and continues to move these molecules at uniform velocities acted on vacuum pressures in force, which creates an acceleration of energy production in the apature involvement. Upon the activation of the system, this starts with turning on the vacuum pumps thereby beginning the production of energy.

The energy produced is E=MO squared, Energy =Mass Oscio squared, in the incumbency of the deluge within the track vescue, which is inductive power. This discovery is a physical law of energy production and the last of its kind that opens the door for future technologies to utilize inductive power. Inductive power is the last vescue in energy production with this innovation (apature) involvement.

The system is initiated with the oil tank under vacuum, which creates resistance. To pull the resistance, another vacuum pump is used at the photo cell. The molecular structure that is derived from the oil molecules is not yet in the 32 foot track assembly.

The methane hydrate crystalline H4 molecule, at the same time under vacuum, creates a counter resistance at the photo cell. With these three components, a molecular structure is created. The vacuum pressure at the casing creates what is known as an inversion filed. The inversion field produces pressure upward, above the casing and into the volume of the aluminum track vescue. The diploid magnetron assembly is the resistance variance in the track of 451 psi, which conditions the molecular structure at exactly 12 inches above the diploid magnetron assembly. The resistive vacuum pressure, at the transverse oil system, creates a high resistance to the diploid magnetron track assembly, thereby keeping the molecules stationary. With 1,400 gallons of oil instilled into the transverse oil system, 2.81 volts in resistance is created. At the grounding plate, the ⅜ inch copper grounding lead generates 2.81 volts A/C, no amp. The static inductors are designed to stimulate the molecules in the oil and methane hydrate crystalline tanks. The vacuum pumps required at the lithium oxide capacitor are designed to hold the energy in the capacitor until it is utilized. The track vacuum is the largest structure and is designed to spin the molecules within the system, at over 2 million miles per hour. When this occurs, a continuous charging is in effect. The charging effect causes a resistance at the resonance field driver assembly and allows for the production of negative ionic particles, at 1.1 hex joules in circumference. The components are balanced in a modulate affect as to allow the molecular structure to move throughout the system at uniform velocities. The inthesies molecular relief allows for a percentage of the molecules to return through the system via the inthesies lead which is a #14 18 K gold wire. It has a displacement of 7:1 and allows for the relief of 881 million molecules per minute to return to the photo cell for further sequestion of energy. In the absence of an inthesies lead, the induction coupler would have to be transversed every 45 days. When the power is in sequestion, the lithium oxide capacitor is designed to trebuchet the power to the grid on demand and automatically. Electricity takes a path of least resistance; thereby giving the energy produced a resistive quality.

The XCL Power Producer System utilizes molecules to operate each and every component in the system in a way that creates energy without a byproduct or emissions into our atmosphere. The energy produced by the XCL Power Producer is uniquely renewable, green, nonradioactive, and continuous. There are no moving parts (except the vacuum pumps), it is good for our environment and eco systems, it is economical, it helps in balancing our climate and ozone, and the baseline energy can be produced in abundance. The XCL Power Producer is a complete power production system and can be used to back up current energy producing technologies. It's contribution to pre existing power plant production systems can enhance their mega watt outlay by 1 trillion 710 billion additional watts annually.

This system uses only one gallon oil and one gallon of methane hydrate crystalline per year. Power production is 45,000 volts @300 amps every 4 minutes continuously for a 14 year cycle, and up to 1,891 miles without loss of power and can be increased or decreased to specification. This system requires only modulated maintenance to monitor and inspect vacuum pump pressures and system outlay.

The advent of inductive power at baseline has unique advantages:

1. The power can be utilized anywhere in the world, with current technologies and A/C systems.
2. The quan factor is increased.
3. The need for chemical transformers is diminished.
4. The grid system is cleansed of H10 and H9 particles and they are gradually reduced. These particles carry a radioactive signature.
5. Through induction plate technologies, wiring for buildings and infrastructures are reduced by 50%.
6. The need for step down transformers can be reduced because it carries a lower amperage ratio in the incumbency in the wire, however takes up more room in the wire. (The lines that carry the current must be 1 inch in size to utilize the full volume of the power).
7. The power that is created is enough to supply cities, countries, counties, corporations, and areas that need power where typical technology does not exist. This includes the North Pole, South Pole, islands, deserts, and mountainous regions, etc., especially in areas of population growth.
8. Due to the conservative value of the innovation, the XCL power Producer System is extremely economical around the world.
9. Compared to typical energy technologies, utilizing the XCL Power Producer Systems as a power production energy source will lower overall costs to consumers due to its conservative nature, and ability to produce larger volumes of power for less money.
10. As the population grows, inductive baseline energy will keep up with demand.
11. The XCL Power Producer opens the door for electrical vehicle technologies without diminishing the common grid.
12. This power production system helps balance the climate in positronic inflection with a negative ionic deluge into our atmosphere, therefore giving us the ability to close the ozone within a predetermined time apature involvement and fortitude in a global infraction.
13. Power generation can be quick to overcome natural disasters.
14. The XCL Power Producer is portable, and can be designed and built anywhere and moved to client and/or government specification or location.
15. Once electrical power production in the XCL Power Producer has started, a loop back can be created at 14 miles out, and returned to the innovation and generate its own power from the innovation.
16. The XCL Power Producer has a scalable ability up to 45 million volts @ 1,981 amps, every 13 minutes.
17. The power produced is a hydrolytic reaction, and therefore be utilized in resonance fielding for medical synergy and the correction of despondency's on the Earth and in the body.
18. The resonance field driver assembly has the capability of dropping the salinity levels of seawater by 41% within indexed distances from the resonance field driver assembly, providing potable water to such areas as island nations in need of drinking water and adding to their potable water supply. The percentage in which the salinity can be dropped is potable for plants, and vegetation, therefore increasing the ability to grow additional crops increasing food supplies.

### BRIEF DESCRIPTION OF THE DRAWINGS

FIG. 1 shows the completed XCL Power Producer System.

FIG. 2 shows the top portion of the oil tank.

FIG. 3 shows the bottom portion of the oil tank.

FIG. 4 shows the infuser and diffuser assembly.

FIG. 5 shows the brass washer for the infuser inductor.

FIG. 6 shows the brass cap for the brass adaptor infuser inductor.

FIG. 7 shows the methane hydrate crystalline tank assembly.

FIG. 8 shows the manufacturing of ⅜ in copper cobalt infracted rod and #14 copper cobalt infracted wire and mold box.

FIG. 9 shows the pouring of the copper cobalt mix.

FIG. 10 shows the Tee inversion area on the oil side (conductive side).

FIG. 11 shows the lithium ore resister.

FIG. 12 shows the Tee inversion area on the methane hydrate crystalline side (inductive side).

FIG. 13 shows the brass induction coupler.

FIG. 14 shows the photo cell components.

FIG. 15 shows the infuser adaptors that go into the photo cell port.

FIG. 16 shows the completed photo cell.

FIG. 17 shows the manufacturing of the casing and mold assembly.

FIG. 18 shows the manufacturing of the oscillator

FIG. 19 shows the hallowed internal vescue of the oscillator.

FIG. 20 shows the completed oscillator

FIG. 21 shows the internal vescue of the oscillator.

FIG. 22 shows the split box casing assembly

FIG. 23 shows the completed split casing with oscillator and stator installed and location of photo cell above the casing.

FIG. 24 shows the bottom portion of the track retainer assembly.

FIG. 25 shows the top portion of the track retainer assembly.

FIG. 26 shows the track retainer stand.

FIG. 27 shows the section view of conductive side of the track and magneto wiring system hook-up.

FIG. 28 shows the section view of the inductive side of the track and magneto wiring system hook-up.

FIG. 29 shows the top of the track assembly over the casing with the photo cell installed.

FIG. 30 shows the casing location in between the conductive and inductive side of the track.

FIG. 31 shows the magneto wiring assembly in the track vescue.

FIG. 32 shows the magneto wiring diagram within the track vescue.

FIG. 33 shows the magneto infusers and locations within the track vescue.

FIG. 34 shows the top portion of the Samarian cobalt diploid magnet assembly.

FIG. 35 shows the bottom portion of the Samarian cobalt diploid magnet assembly.

FIG. 36 shows the box for the no-cohedence diffuser (NCD).

FIG. 37 shows the NCD fusible link.

FIG. 38 shows the resonance field driver plate assembly.

FIG. 39 shows the bottom portion of the resonance field driver.

FIG. 40 shows the lithium oxide capacitor.

FIG. 41 shows the completed bell infuser assembly.

FIG. 42 shows the bell infuser and copper lead assembly.

FIG. 43 shows the center trisolator for transverse oil system.

FIG. 44 shows the partial view of the transverse oil grounding field assembly.

FIG. 45 shows the reverse vacuum plug assembly for the transverse oil system.

FIG. 46 shows the static inductor.

FIG. 47 shows the completed static inductor strapped to the wall.

FIG. 48 shows the safety allowance cooling duct for the high inductor rod.

FIG. 49 shows the 90 degree angle for the cooling duct system.

FIG. 50 shows the safety insulator sheets for the casing.

FIG. 51 shows the non-conductive protective building surrounding the resonance field driver plate assembly.

FIG. 52 shows a vacuum pump.

### DETAILED DESCRIPTION OF THE DRAWINGS

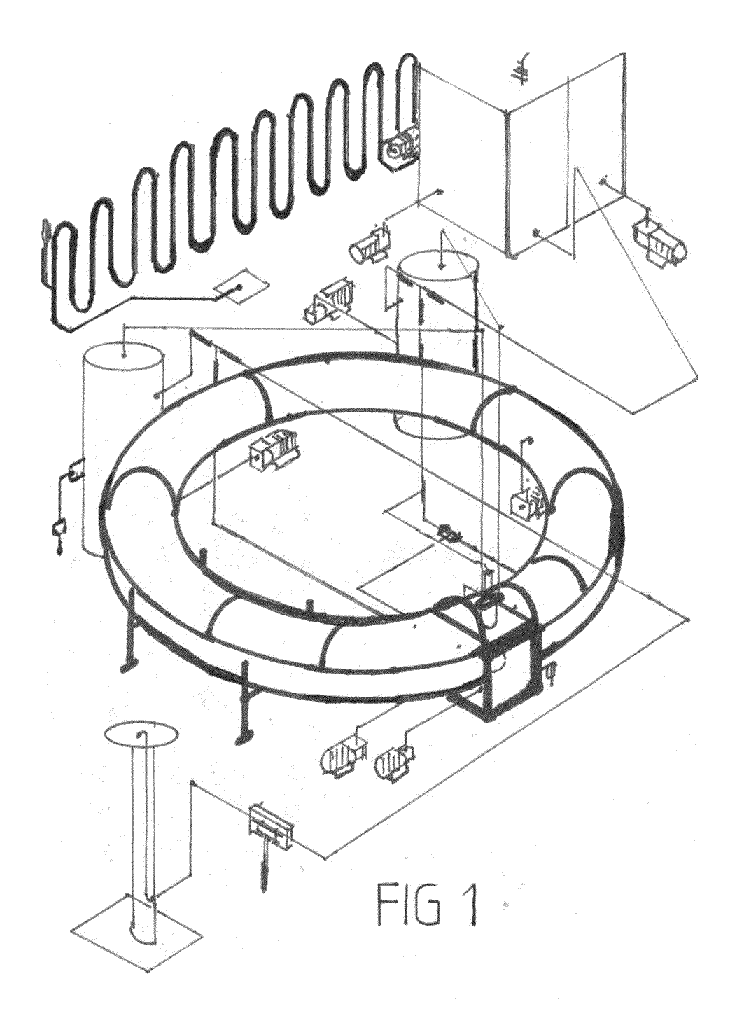

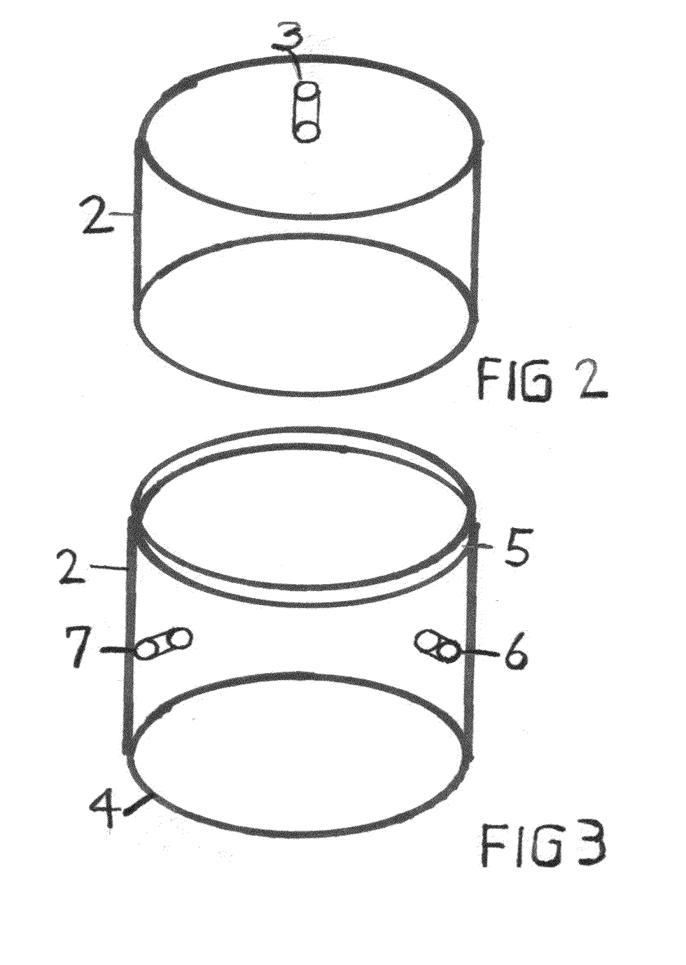

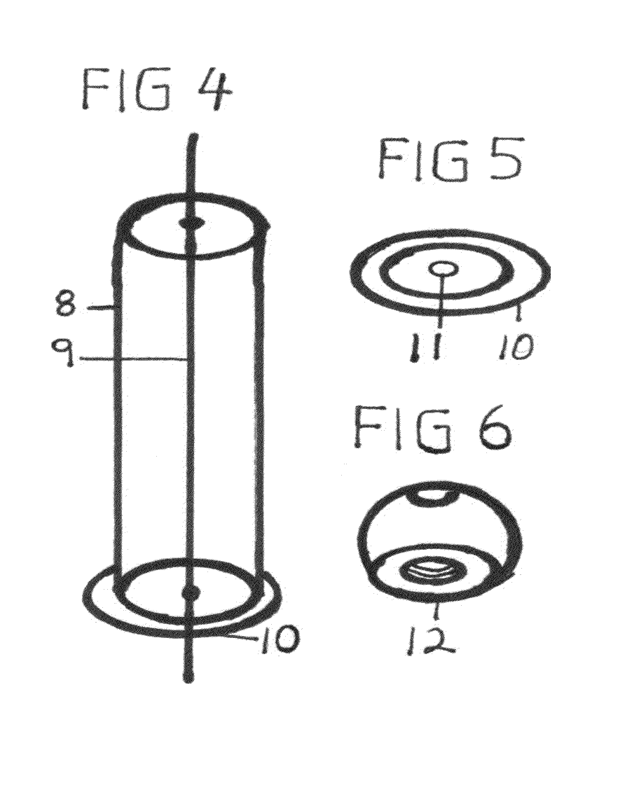

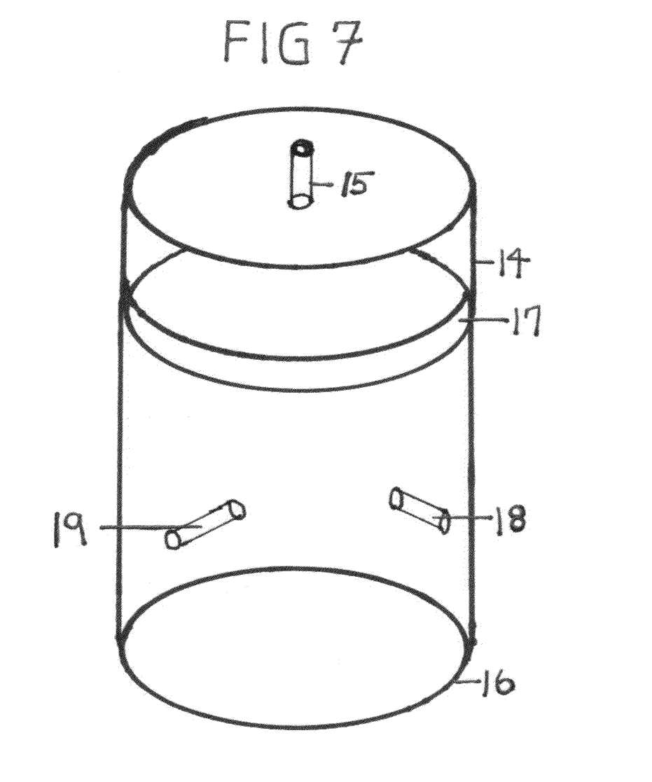

FIG. 1 depicts the completed XCL Power Producer System. FIG. 2, numeral 1 shows a 12 inch portion of the brass oil tank. The brass oil tank has a total capacity of 22.5 gallons. Numeral 2 shows a ⅜ inch wall thickness. Numeral 3 shows a ¾×4½ inch brass nipple soldered on center of the top portion of the tank. FIG. 3, numeral 4 shows the bottom portion of the brass oil tank, 29 inches in height×21⅜ inches in diameter. Numeral 5 shows the internal lip 1⅛ inches. Numeral 6 shows a ¾ inch×4½ inch brass nipple soldered to an infusion port. Numeral 7 shows a ¾ inch×4½ inch brass nipple soldered to the vacuum port. FIG. 4 shows the manufactured infuser and diffuser assembly. Numeral 8 shows the brass portion of the assembly. Numeral 9 show the #14 copper cobalt infracted wire feed through. FIG. 5, numeral 10 shows the internal sealing washer 1⅛ inch× 1/16 inch. Numeral 11 shows the feed through hole drilled ⅛ inch on center to accommodate numeral 9. FIG. 6, numeral 12 shows the ¾ inch brass cap with ⅛ inch hole drilled on center to accommodate numeral 9.

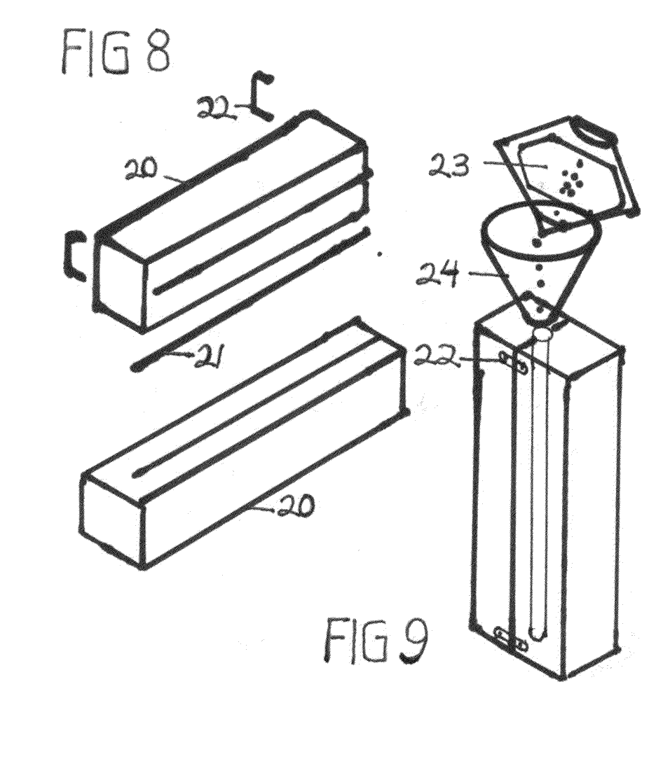

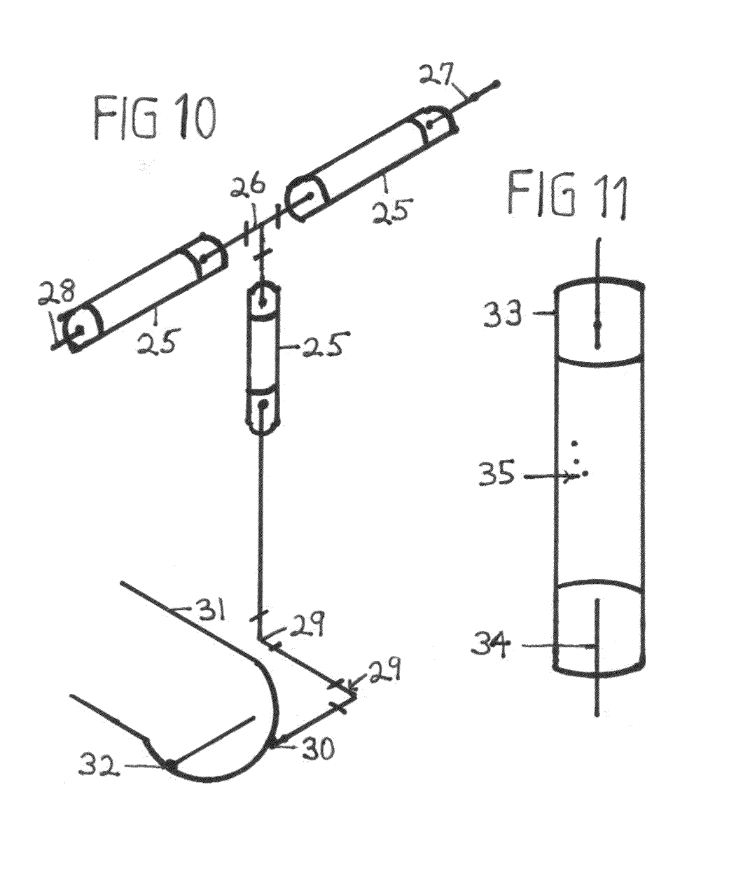

FIG. 7 depicts the methane hydrate crystalline steel tank with a 14 gallon capacity, diameter of 21 ⅜ inches. Numeral 13 shows the top 12 inch portion. Numeral 14 shows ½ inch wall thickness. Numeral 15 shows the steel ¾ inch×6 inch nipple welded on center of ⅞ inch drilled hole. Numeral 16 shows the bottom portion of the tank, 27⅞ inches in height. Numeral 17 shows the interior lip 1⅛ inches welded portion of the tank. Numeral 18 shows the steel ¾×6 inch nipple welded on center of a ⅞ inch drilled hole for the infuser port. Numeral 19 shows a steel ¾×6 inch nipple welded on center of a ⅞ inch drilled hole for the vacuum port. FIG. 8 depicts the manufacturing of the ⅜ inch copper cobalt infracted rod and #14 copper cobalt infracted wire. Numeral 20 shows the mold assembly. Numeral 21 shows the ⅜ inch copper cobalt infracted rod. Numeral 22 shows the mold bracket pins (2 each). FIG. 9, numeral 23 shows the pouring of the copper cobalt mix at 1660-1710 degrees F. Cobalt is granulated to salt consistency and mixed to a 5:1 displacement, and cooled for a minimum of 14 hours. Rods and wires are manufactured at 14 foot lengths and cut to fit the system as needed. Numeral 24 shows the funnel delivery of the copper cobalt mix.

FIG. 10 shows the T-Inversion area of the system, conductive side of the linear track and assembly. Numeral 25 shows the copper lithium ore resistors, ¾ inch×12.18 inch in length. Numeral 26 shows the ⅜ inch copper cobalt infracted inversion tee. Numeral 27 shows the ⅜ inch copper cobalt infracted rod going to numeral 6. Numeral 28 shows the ⅜ inch copper cobalt infracted rod going to numeral 117. Numeral 29 shows the ⅜ copper cobalt infracted 90 degree angle. Numeral 30 shows the infuser connector for the ⅜ inch copper cobalt infracted rod which ties into the tee inversion area. Numeral 31 shows the #14 copper wire magneto. Numeral 32 shows the infuser connection for the conductive side which connects to numeral 31 and the stub out that goes to the induction coupler. FIG. 11 shows the lithium ore resistor. Numeral 33 shows the ¾ inch resistor cap. Numeral 34 shows the lithium ore resistor ¾ in×12.18 inch in length with ⅜ in copper cobalt infracted rod stub out. Numeral 35 shows granular lithium ore—no larger than ⅛ inch in diameter.

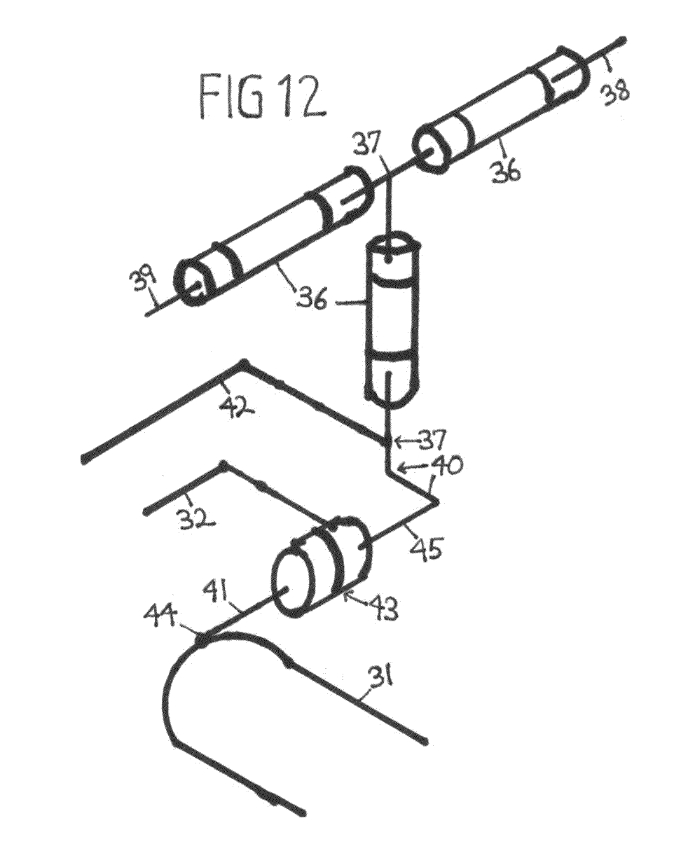

FIG. 12 shows the T-Inversion area of the inductive side of the linear track and assembly. Numeral 36 shows the ¾ inch lithium ore resistors. Numeral 37 shows the ⅜ inch copper cobalt infracted tee. Numeral 38 shows the ⅜ inch copper cobalt infracted rod going to numeral 18. Numeral 39 shows the ⅜ inch copper cobalt infracted rod going to the 1 inch stranded sheathed wire to the capacitor numeral 138. Numeral 40 shows the ⅜ inch copper cobalt infracted 90 degree angles. Numeral 41 shows the ⅜ inch copper cobalt infracted rod going to numeral 9, track infuser, located in numeral 44, magneto track assembly. Numeral 42 shows #14 18 K gold wire molecular (inthesies) relief which ties into the top of the photo cell, numeral 51. The gold is a 7:1 displacement which allows for 881 million molecules in relief per hour. Numeral 43 shows the induction coupler location outside the track.

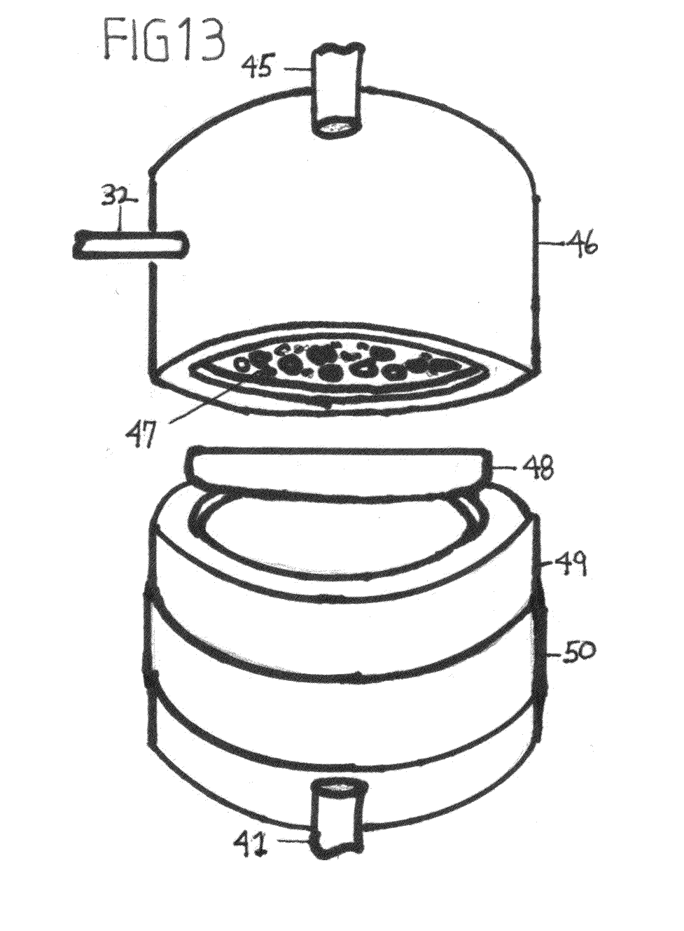

FIG. 13 shows the induction coupler, 9.418 inches in length with an internal vescue of 3.14 inches, ¾ inch wall thickness made of brass. It is designed to have 2 sides, one dry side, and one wet side with methane hydrate crystalline, filled prior to installation, then soldered. Numerals 32, 41, & 45 show impingement values of ⅜ inch into the induction coupler. FIG. 12, numeral 44 shows the infuser connection location and the tie in for the ⅜ inch copper cobalt infracted rod for the dry side of the induction coupler, FIG. 13 numeral 41. Numeral 45 shows the ⅜ inch copper cobalt infracted rod going to the high inductive side tee inversion FIG. 12. FIG. 13, numeral 46 shows the wet side (the downstream side of the molecular flow) of the induction coupler, ¾ inch wall thickness. Numeral 47 shows granular methane hydrate crystalline. Numeral 48 shows the ¾ inch copper flux plate, 3.14 inch in diameter, which acts like a check valve to disallow the molecular structure in the magneto from entering the high induction side. Numeral 49 shows the dry side (the upstream side of the molecular flow) of the induction coupler. Numeral 50 shows the aluminum anti fracture slip coupler machined to fit on exterior of the coupler to protect the flux plate after soldering, 4.64 inch diameter, soldered on center when completed.

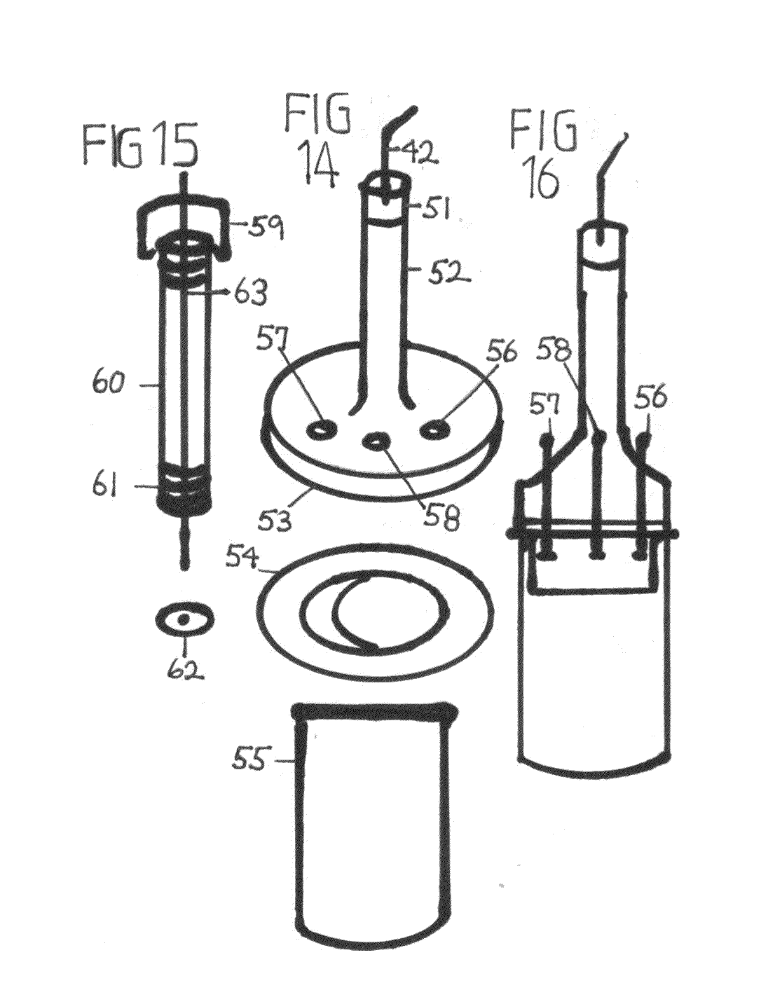

FIGS. 14 & 16 show the photo cell, 28.768 inches in length total. Numeral 51 shows the 1½ inch aluminum molecular relief cap. Numeral 52 shows the 1½ inch aluminum pipe, 18.1 inches in length, relief vescue. (Numerals 51 & 52 are the aluminum encumber portion of the photo cell). Numeral 53 shows the flange, ⅞ inch in thickness, which numeral 52 is welded to. Numeral 54 shows the internal flange with an external, outside diameter of 5.169 inches, and tapers to 3.4 inches in internal vescue to fit inside glass vescue, numeral 55. Numeral 55 shows the glass portion, 9.418 inches in length, with an internal vescue of 3.419 inches in diameter, ⅜ inch wall thickness on each side, external diameter 4.169 inches. FIG. 16, numeral 56 shows the infuser port for the photo cell, and an adaptor that tie into numeral 3. Numeral 57 shows the infuser port which gets an adapter and ties into numeral 15. Numeral 58 shows the center port for the vacuum pump. FIG. 15 depicts a diffuser assembly (see FIG. 4) made of aluminum. Numeral 59 shows a ½ inch brass cap. Numeral 60 shows the ½ inch×3½ inch aluminum threaded infuser nipple with a #14 copper cobalt infracted wire with 1/16 inch impingement into the photo cell. Numeral 61 shows the internal flange of the aluminum nipple. Numeral 62 shows the ⅝ inch aluminum washer welded on the inside of the photo cell top portion of infuser port assembly with ⅛ inch hole drilled on center to accept numeral 63 feed through. Numeral 63 shows a #14 copper cobalt infracted wire feed through. FIG. 16 shows a completed photo cell.

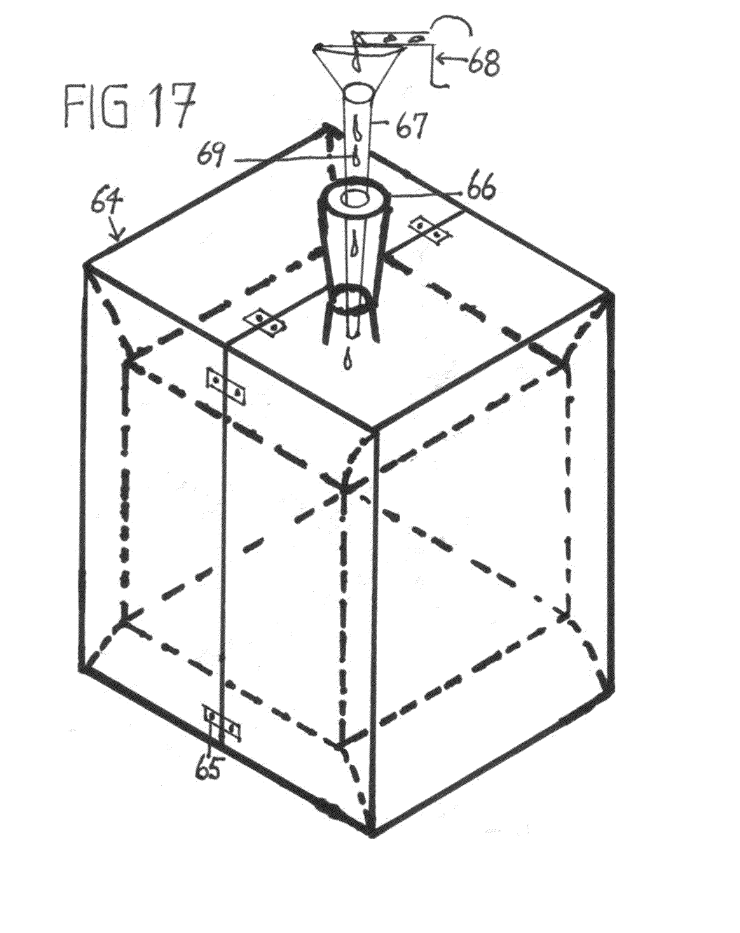

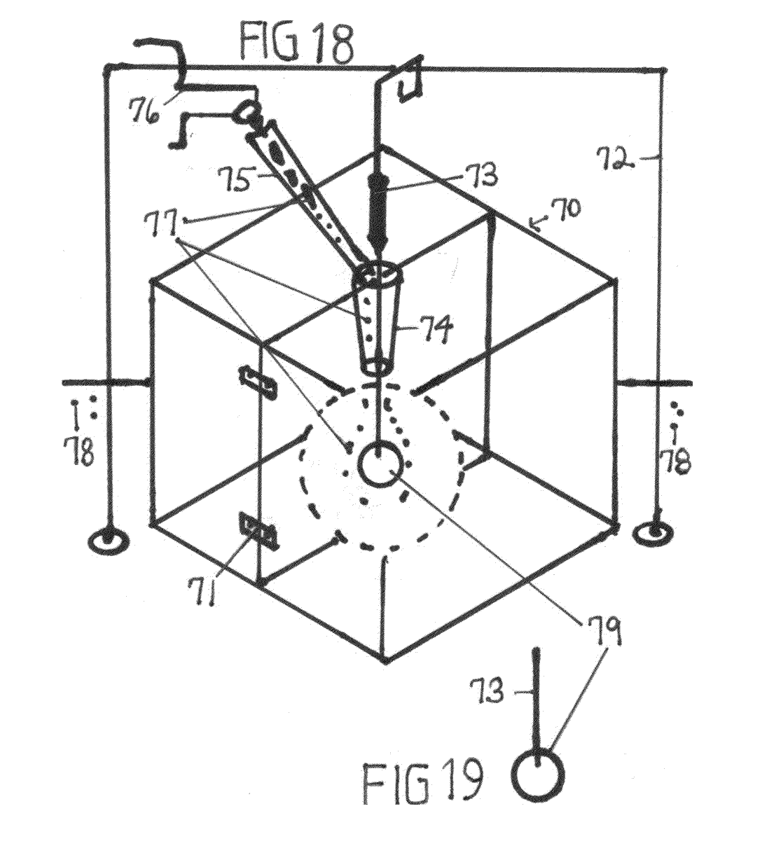

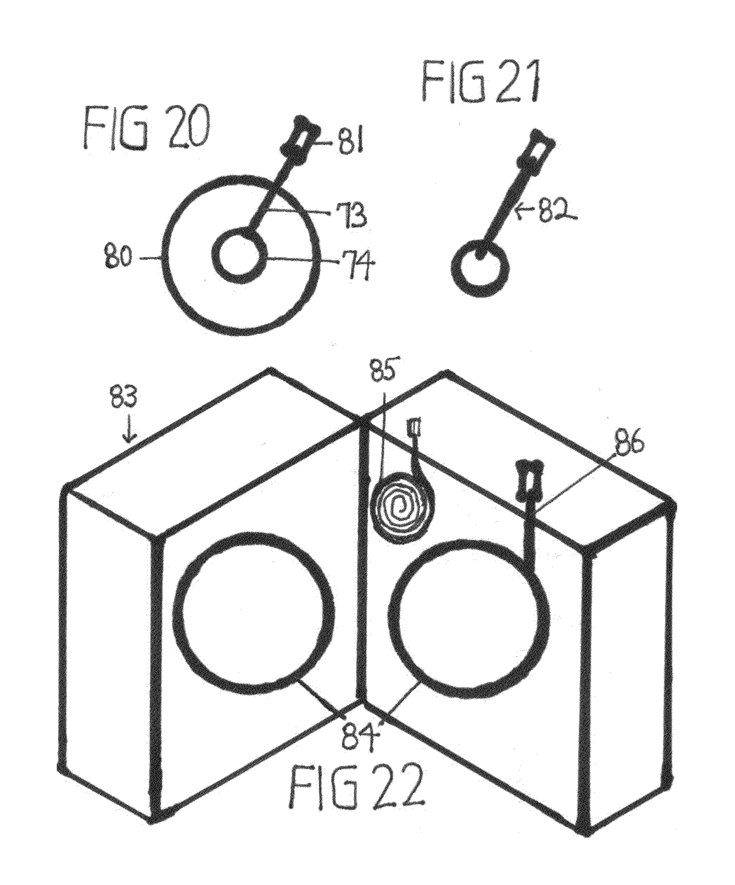

FIG. 17 shows the manufacturing of the casing, 24×24 inch brass. Numeral 64 shows the aluminum mold assembly. Numeral 65 shows the aluminum mold pin connectors, 16 each, 4 per side. Numeral 66 shows the inlet to the mold box. Numeral 67 shows the funnel. Numeral 68 shows the smelter. Numeral 69 shows the molten yellow brass heated to 1660-1710 degrees F. After poured into the mold box, it is cooled down for 13 days, pulled out of the mold box and left to solidify for an additional 2 days; sanded and polished prior to cutting. FIG. 18 shows the manufacturing of the oscillator with an external diameter of 7.18 inches and an internal vescue of 2.18 inches, in brass. Numeral 70 shows an aluminum mold casing of 14.18 inches cubed with 7⅛ inch machined spherical internal vescue. Numeral 71 shows pin connectors, 12 each, 3 per side. Numeral 72 shows the internal vescue rack of 1 inch steel pipe 22 inches in height, 22 inches in width, threaded into feet and mounted to plywood in sandbox. Numeral 73 shows a #14 copper cobalt infracted vacuum lead wire used as a hanger. Numeral 74 shows the inlet to the mold. Numeral 75 shows the funnel. Numeral 76 shows the smelter. Numeral 77 shows the molten yellow brass heated to temperature of 1660-1710 degrees F.; to be cooled for 13.8 days; then removed from the mold and left to solidify 1.8 additional days, sanded and polished. Numeral 78 shows the sand. FIG. 19, numeral 79 shows the hallowed internal vescue. FIG. 20 shows the completed oscillator. Numeral 80 shows the completed brass oscillator, 7.18 inches in diameter. Numeral 81 shows the tube adaptor. FIG. 21, numeral 82 shows the completed internal vescue inlet assembly for the oscillator. Then vacuum down the oscillator to 13.914. The #14 copper cobalt infracted wire, numeral 73 is then severed and the oscillator is installed into the casing.

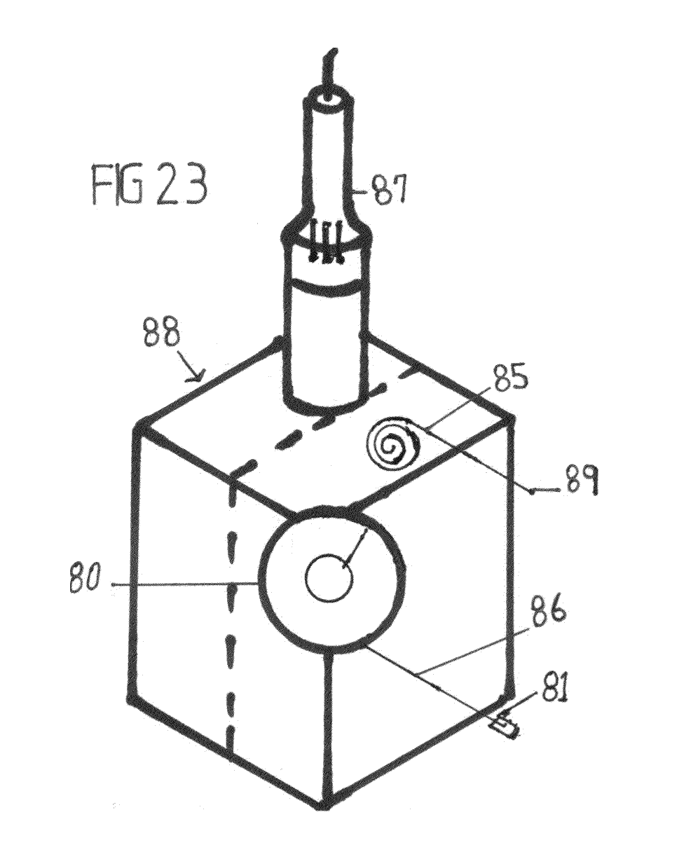

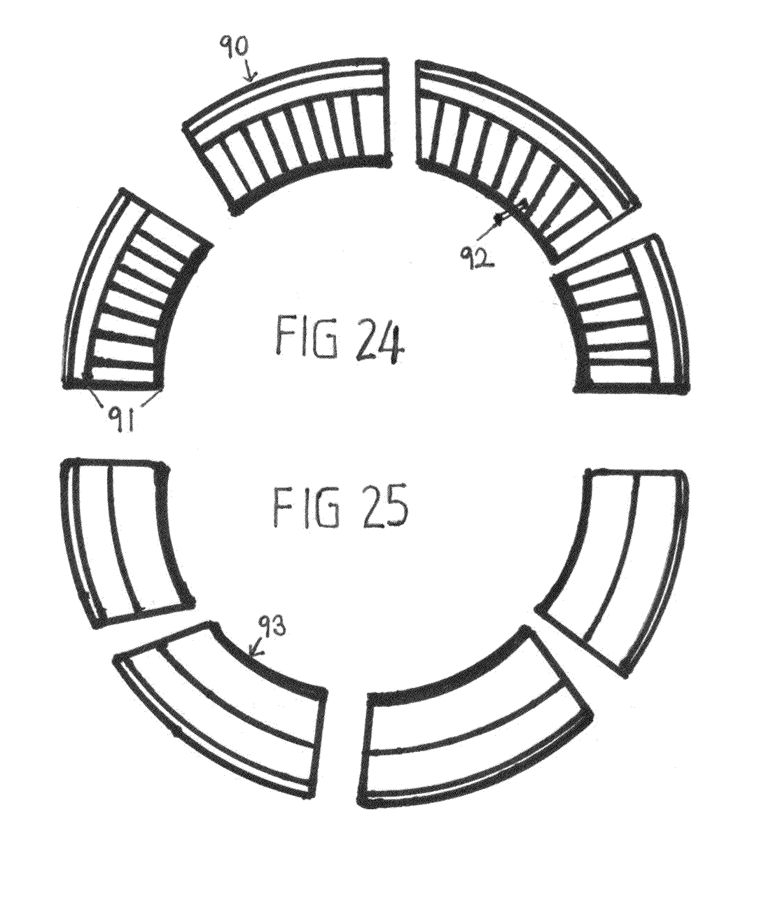

FIG. 22 shows the split box casing. Numeral 83 shows the split box casing machined to 7⅛ inches. Numeral 84 shows honed out oscillator space. Numeral 85 shows the space location groove installed into the casing, and stator, ¾ inch diameter stranded copper wire, coiled in the casing for 38.18 inches in length, and extended for an additional 2 inches to total 40.18 inches in length, and accepts 480 volts single phase induction, 12.1 amp. Numeral 86 shows the permanent vacuum lead assembly, a # 14 copper cobalt infracted wire with an impingement variance of 1/16 inch into the honed oscillator area. FIG. 23 shows the location of the photo cell over the split box casing with the oscillator and stator. Numeral 87 shows the completed photo cell and location. Numeral 88 shows the completed 24×24 inch split casing assembly, soldered. Numeral 89 shows the 1 inch coupling.

FIG. 24 shows the track retainer assembly bottom portion, fractionated in 8 sections (4 are shown) for a total of 32.18 feet in length, in an oval configuration at 13.18 degrees, with an internal vescue width of 24 in., wall thickness of ⅜ in, made of 99.9% aluminum. The distance of the track retainer assembly from the casing to the finished retainer on the opposite side measures 14 feet. Numeral 90 shows a portion of the bottom section. Numeral 91 shows the track retainer bar and spanner assembly to hold down the diploid magnetron assembly upon installation. Numeral 92 shows the track internal vescue tube vacuum port with welded aluminum nipple, ½inch in diameter×6 inches in length with no feed through. FIG. 25, numeral 93 shows the track retainer assembly top portion,

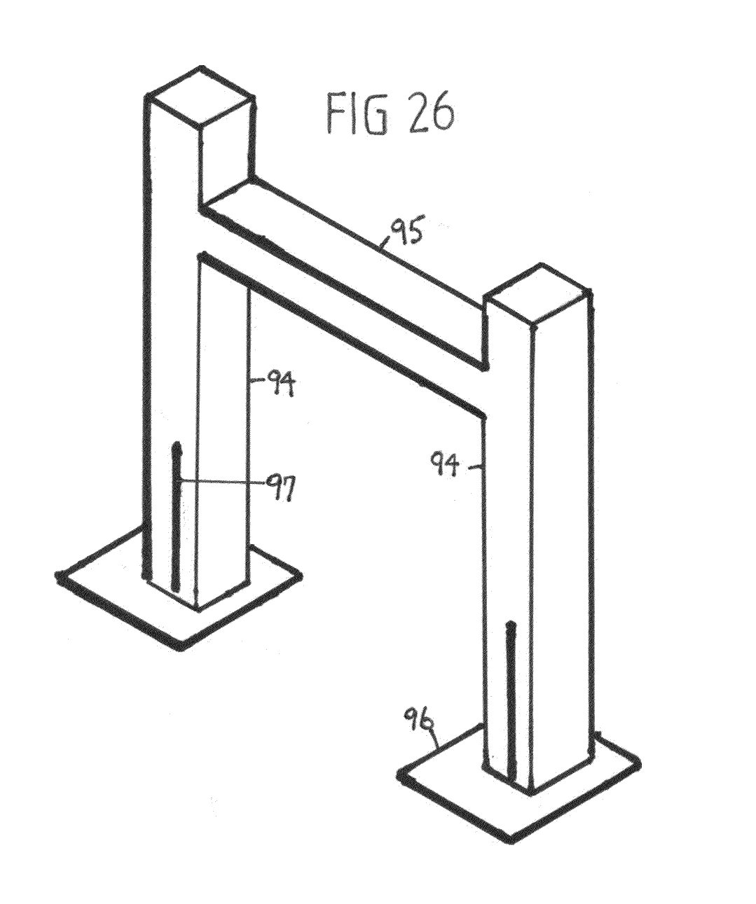

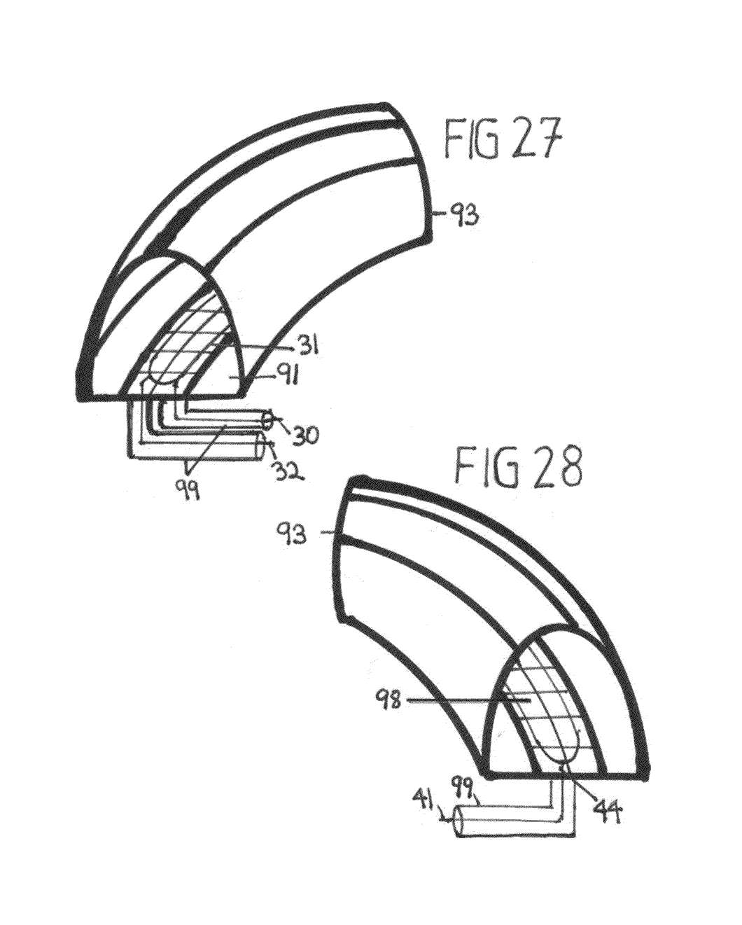

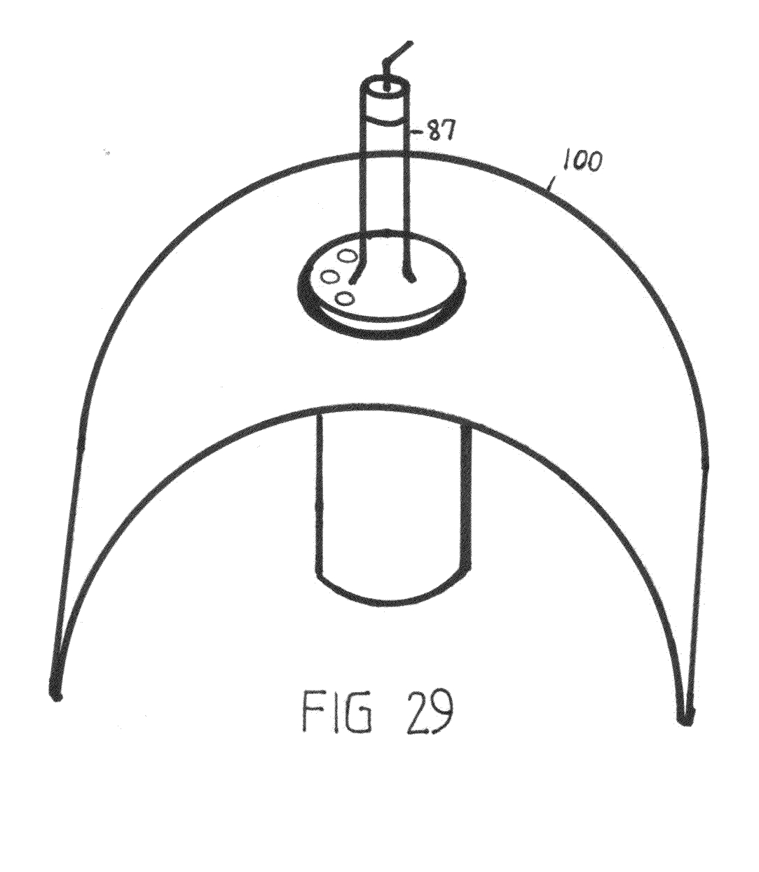

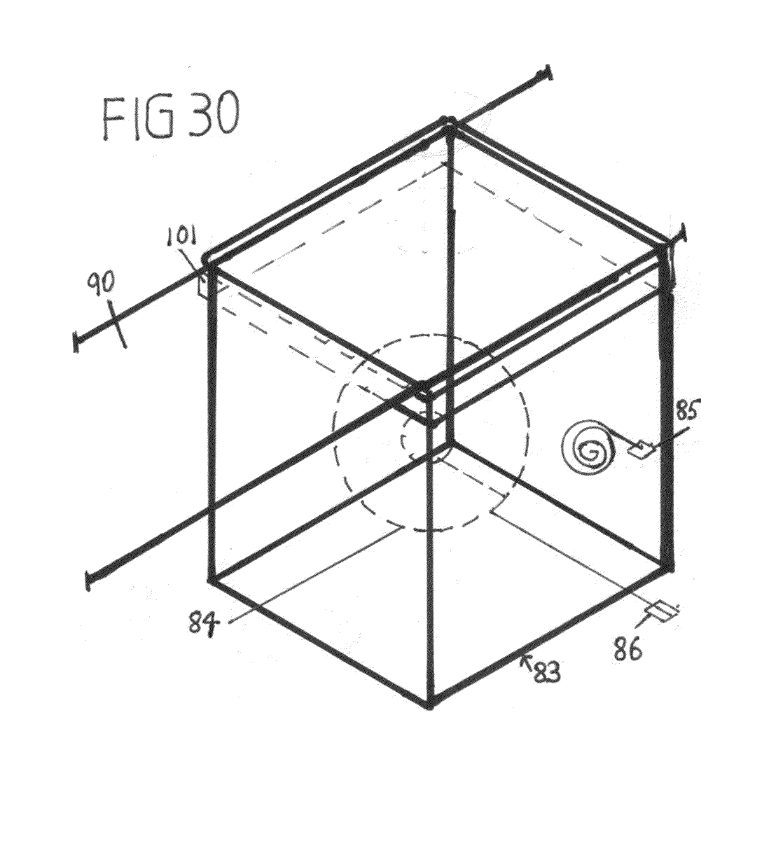

fractionated in 8 sections (4 are shown) for a total of 32.18 feet in length, in an oval configuration at 13.18 degrees, with an internal vescue width of 24 in, wall thickness of ⅜in., made of 99.9% aluminum, to match the bottom portion. FIG. 26 shows the adjustable track retainer stands, 10 each, 5 on each side, with height of 31 and width of 26⅛ inches, made of aluminum. There is a 13 inch aluminum worm screw, which is welded to a 13 square inch aluminum plate, ¼ inch thickness that is screwed into the end of the stock, giving a total variance of 31-41 inches. Numeral 94 shows 2 inch×4 inch aluminum square stocks that are threaded and machined in a worm screw design on one end for 13 inches. Numeral 95 shows 2 inch×4 inch aluminum center support welded to the vertical supports, 26⅛ inches, with a set down distance of 4.18 inches. Numeral 96 shows 13 inch square aluminum plate, ¼ inch thickness with welded aluminum worm screw, numeral 97. FIG. 27 shows the fractionated portion of the conductive side of the track vescue with the Samarian cobalt magnetron assembly and 2 infusers. Numeral 98 shows the Samarian cobalt magnets, 4 inch×4 inch×½ inch each. Numeral 99 shows the brass conduit for infuser wire with a set back distance not to exceed 2.18 inches from the side of the casing. FIG. 28 shows the fractionated portion of the opposite side of the track, which is the inductive side of the track with 1 infuser and # 14 copper cobalt infracted wire, numeral 41. FIG. 29 shows the photo cell installed on top of the track vescue assembly, aluminum, which measures the spanned distance between the conductive and inductive sides of the track, and welded after installation of the track assembly. Numeral 100 shows the top of the casing vescue assembly FIG. 29, over the casing FIG. 30, aluminum welded to the track bars numeral 101 and retainer assembly. Casing is enclosed in ⅜ inch aluminum box, site fitted and welded. FIG. 30 shows the casing fitted to the bottom track retainer, numeral 90, where Samarian cobalt magnets intersect the casing. The magnetron assembly starts at the conductive side of the track and ends at the inductive side, with no magnetron assembly over the casing. Numeral 101 shows the track bars that hold the track to the casing, mounted and recessed below the finished elevation of the casing. The bars are 1½ inch aluminum×½ inch thickness, 2 bars are 24⅛ inches in length, and 2 bars are 24⅝ inches in length and screwed to casing and welded to the track retainer assembly to seal the casing to the entire track vescue.

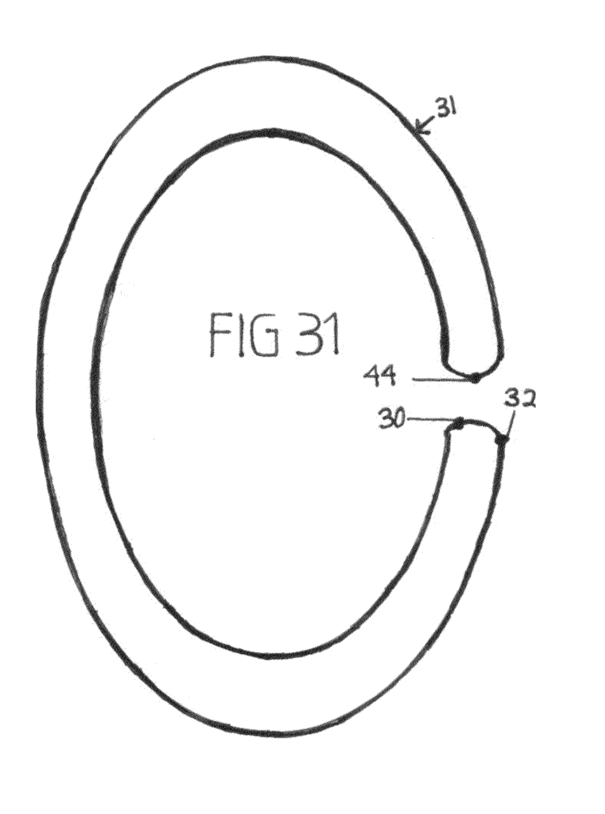

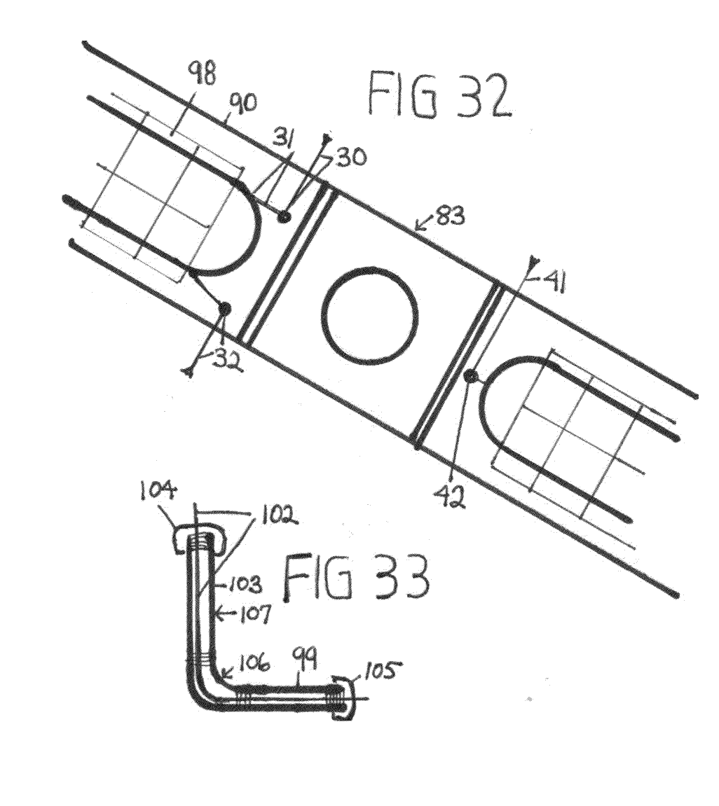

FIG. 31 shows the magneto #14 copper wire, 64.18 feet in length. FIG. 32 shows the bottom track retainer magneto assembly and 3 infuser locations. FIG. 33 shows the magneto infusers to be installed within the track vescue, numerals 30, 32, and 44, each with # 14 copper cobalt infracted wire feed through. Numeral 102 shows the infuser assembly and wire. Numeral 103 shows the ½ inch×3½ inch aluminum nipple. Numeral 104 shows the ⅝ inch aluminum washer. Numeral 105 shows the ½ inch brass cap. Numeral 106 shows the threaded brass 90 degree angle, screwed to an aluminum nipple on the track retainer assembly. Numeral 107 shows the completed infusers, three each, numerals 30, 32, and 44.

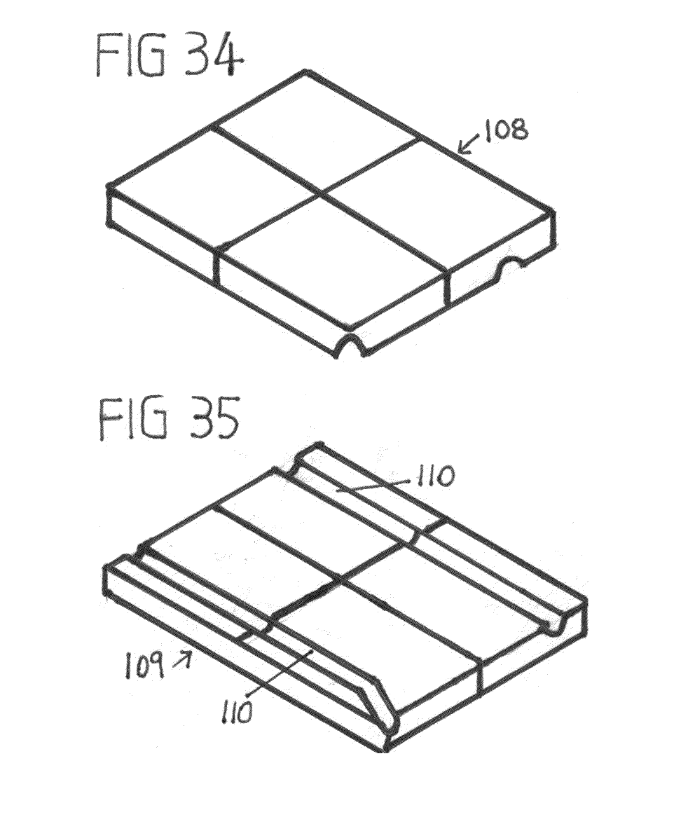

FIG. 34 shows the Samarian cobalt diploid magnets, 4 inches×4 inches, ½ inch thickness, with a 451 psi resistance quality, and their displacements. Numeral 108 shows the top set of the diploid magnet assembly. FIG. 35, numeral 109 shows the bottom set of the diploid magnet assembly. Critical juncture: the first only 4 inch×4 inch Samarian Cobalt magnet is cut at a 45 degree angle for a length of 1.18 inches to meet with the 1/16 inch groove set 1.18 inches from the side. Numerals 110 & 111 shows the machined groove 1/16 inch deep, 1.18 inches from the side, for the low inductor magneto numeral 31, which loops around the track assembly and becomes the groove for the high inductor magneto on the other side, infuser numeral 32, which ties into the induction coupler.

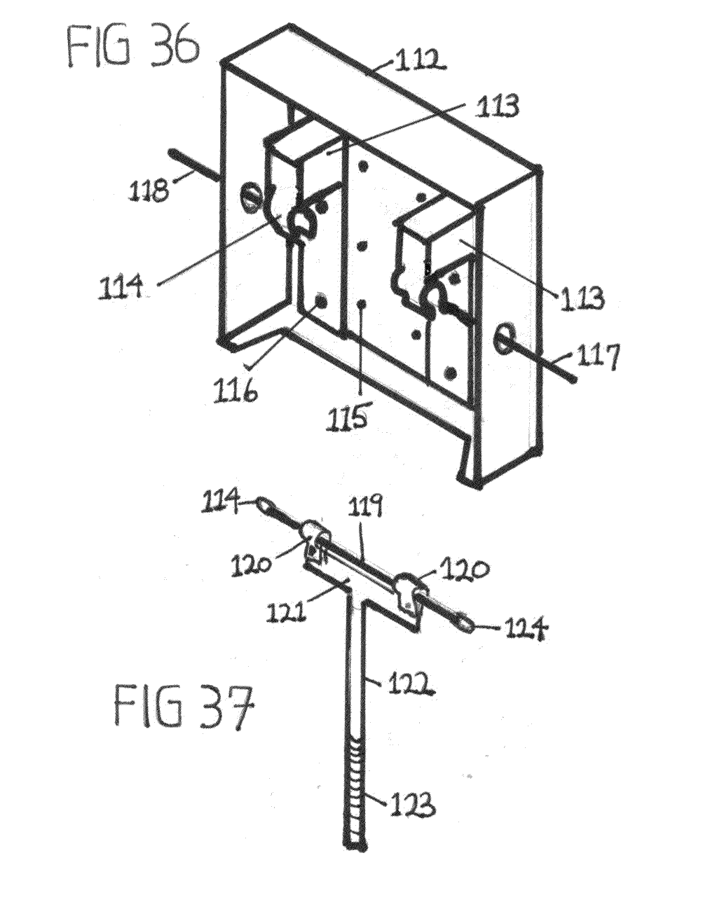

FIG. 36 shows the NCD (no cohedence diffuser) box assembly. Numeral 112 shows the non conductive polybutylene, 13.18 inches in length, 2 inches in width, and 13.18 inches in height. Numeral 113 shows the aluminum L bars, 11.18 inches in length, 1½ inches in width, for the L bracket assembly. Numeral 114 shows the cohedence clip. Numeral 115 shows the ⅜ inch lag bolts, 6 each. Numeral 116 shows the ⅜ inch aluminum blots to hold the L bracket to the box, 4 each. Numeral 117 shows the ⅜ inch copper cobalt infracted rod coming from tee inversion area numeral 28. Numeral 118 shows the ⅜ inch copper cobalt infracted rod going to ⅜ inch stranded copper wire numeral 128 in the resonance field driver assembly. FIG. 37 shows the diffuser handle assembly. Numeral 119 shows the ⅜ inch copper cobalt infracted rod, 11.18 inches permanently affixed to the NCD diffuser. Numeral 120 shows the aluminum clips, 2 each, permanently attached to the handle which holds the diffuser rod. Numeral 121 shows the polybutylene spanner assembly. Numeral 122 shows the handle 24 inches in length. Numeral 123 shows the rubber grips, 14 inches in length. Numeral 124 shows the ⅞ inch leg brass saddle assembly, permanently affixed to ⅜ inch cobalt infracted diffuser rod numeral 119.

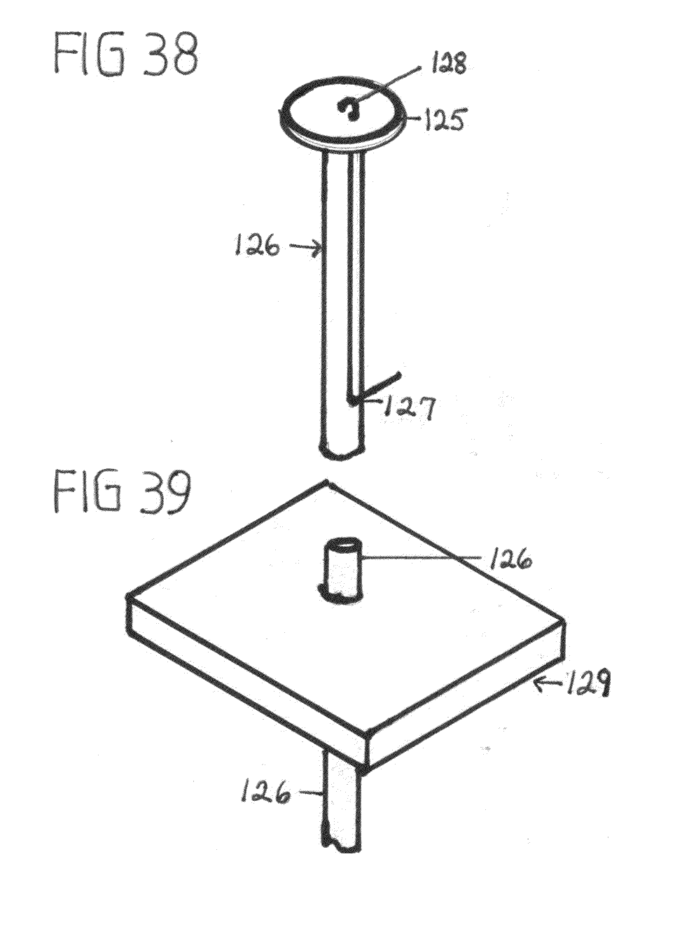

FIG. 38 shows the resonance field driver plate assembly. One 4 inch steel pipe, 20 feet in length and a ¾ inch steel plate, 32 inches in diameter, welded together on center. Numeral 125 shows ¾×32 inch steel plate with hole drilled off center for ⅜ inch stranded resonance copper wire, numeral 128, through bolted to the plate. Numeral 126 shows the bottom portion of the resonance field driver. Numeral 127 shows the hole drilled into the pipe at 13 inches from the bottom to accommodate numeral 128. Numeral 128 shows the ⅜ inch stranded copper wire threaded through the pipe. FIG. 39, numeral 129 shows 5 foot square concrete pad without rebar, 4 inches thick that encompasses the 1,400 foot driver.

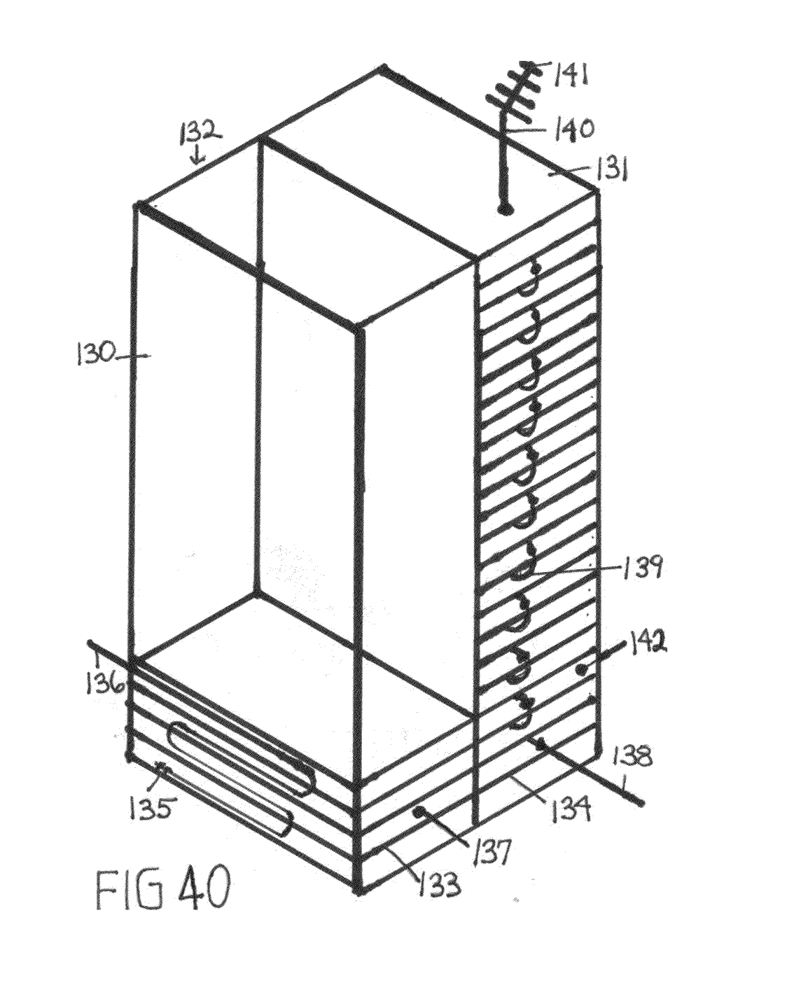

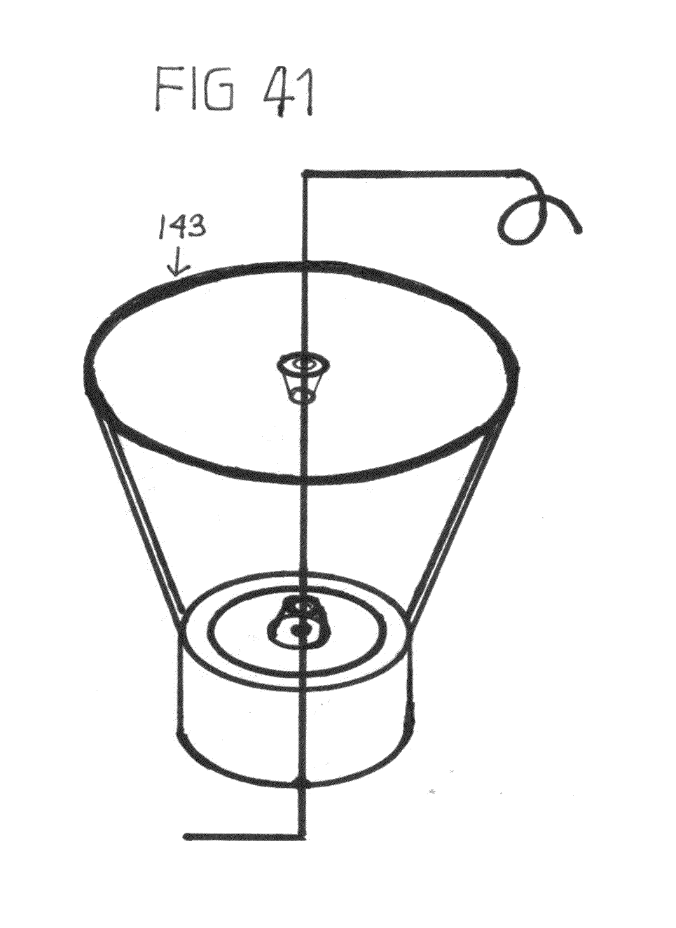

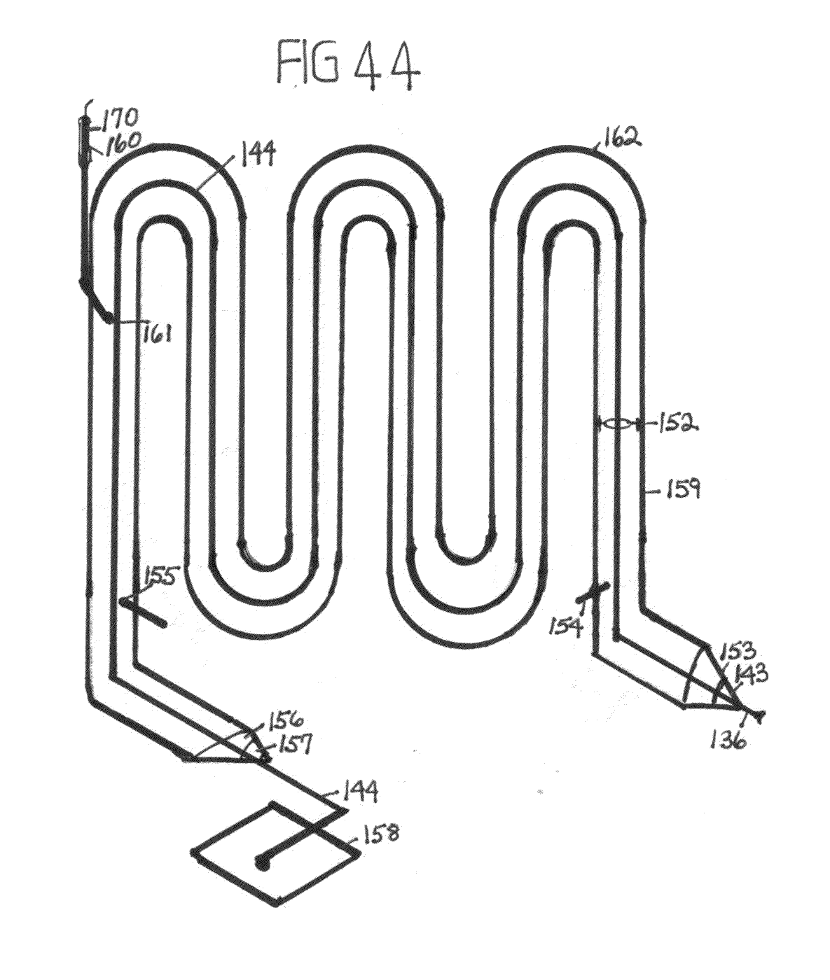

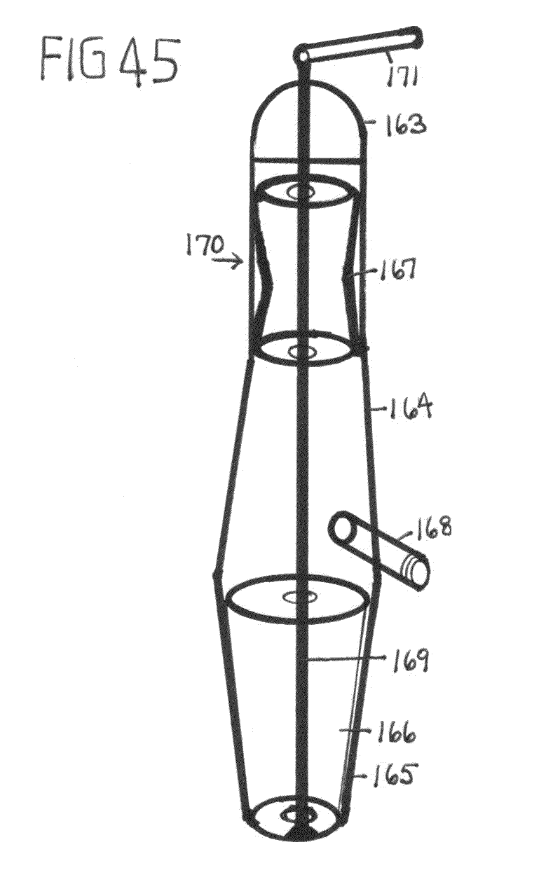

FIG. 40 shows the lithium oxide capacitor, steel, 13.6 feet in height, ¾ inch wall thickness, 42 inches wide divided into 2 sections, each section is 21 inches wide, with 1 inch steel tiers, welded 6 inches apart as they are packed with lithium ore, numerals 133 and 134. The lithium ore is ball milled between ⅜ and ⅞ inch in diameter, as each tier is packed; the next plate is welded until all tiers are completed. Numeral 130 shows the transverse side. Numeral 131 shows the inductive side. Numeral 132 shows the completed capacitor. Numeral 133 shows the 4 tiers on the transverse side. Numeral 134 shows the 23 tiers on the inductive side. Numeral 135 shows the 1 inch stranded copper wire that begins at the bottom of the transverse side. Numeral 136 shows the 1 inch stranded copper wire numeral 135 where it exits the capacitor 31.18 inches from the ground, to tie into FIG. 41 bell infuser assembly at the transverse oil system FIG. 44. Numeral 137 shows the location of the transverse vacuum port, 9¾ inches from the bottom, in a ⅞ inch drilled hole with a ¾ inch×6 inch welded nipple. Numeral 138 shows the inductive 1 inch stranded copper lead coming in the high inductive conical side of the lithium oxide capacitor (start of conical loop). Numeral 139 represents the conical loop. Numeral 140 shows the end of the conical loop and ties into the contactor. Numeral 141 shows the ceramic contactor that leads to the grid. Numeral 142 shows the conical side of the vacuum port with ¾ inch×6 in nipple.

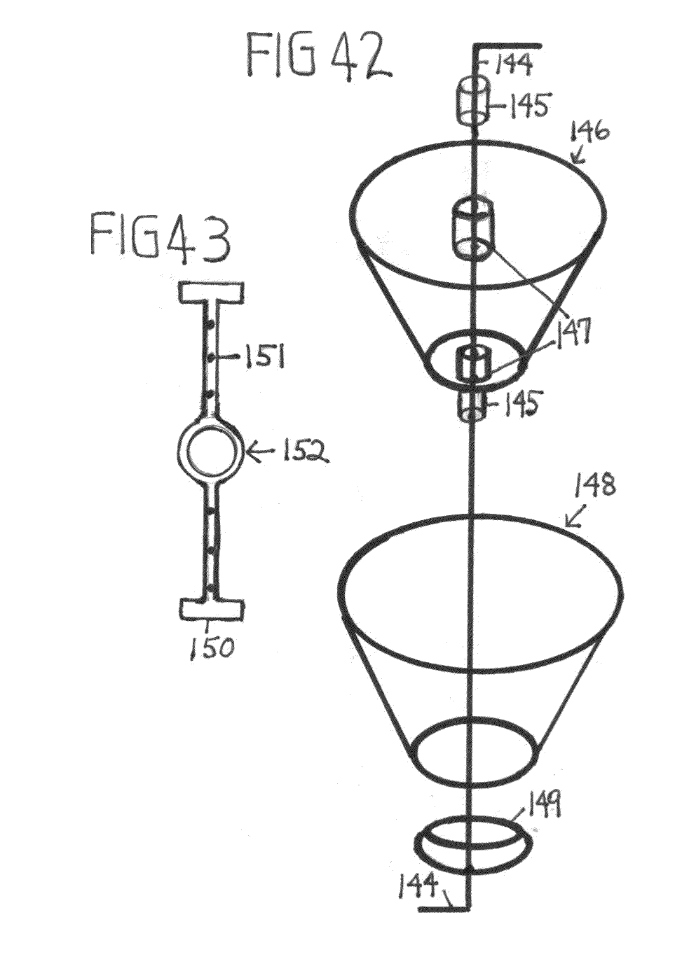

FIG. 41, numeral 143 shows the completed bell infuser assembly. FIG. 42, numeral 144 shows the ⅜ inch stranded copper lead, 581 feet in length connects to FIG. 40, numeral 136, 1 inch stranded copper wire. Numeral 145 shows a brass adapter 2.51 inches in length. Numeral 146 shows a solid steel bell welded to steel bell reducer numeral 148. Numeral 147 shows a machined well that accepts brass adapter numeral 145 and is hydraulically pressed into numeral 146. Numeral 148 is a steel bell reducer 12.2 inches in length with a diameter of 10 inches tapered to 2 inches. Numeral 149 is a 2 inch steel cap.

FIG. 43 is a center trisolator for the transverse oil system. Numeral 150 is a adjustable T bracket. Numeral 151 is a ⅜ inch stove nut and bolt, polycarbonate, 3 sets for each of 2 T brackets. Numeral 152 is the eye of the trisolator.

FIG. 44 shows the transverse oil grounding field assembly. There are 20 steel pipes, numeral 159, each 25 feet in length, 14 inches in diameter welded together fitting to fitting for a total of 500 feet. Numeral 153 shows the 14×10 inch bell reducer, steel. Numeral 154 shows the ¾ inch×6 inch nipple welded to the vacuum port. Numeral 155 shows the oil discharge port and pipe, 2×12 inches, with 2 inch cap. Numeral 156 shows the 14×10 inch bell reducer at the end of the system. Numeral 157 shows the 10×2 inch bell reducer with the diffuser at the end of the system. Numeral 158 shows the grounding plate 13×21 inches, ⅜ inch steel thickness, with ½ inch nut welded on center with bolt. Numeral 159 shows the beginning of the 14 inch steel pipe riser assembly. Numeral 160 shows the 2 inch×10′ 6″ in length steel pipe that ties into the last riser. Numeral 161 shows the oil entrance port for the steel pipe numeral 160. Numeral 162 shows the 90 degree angle.

FIG. 45 shows the reverse vacuum plug assembly, 38.58 inches in length. Numeral 163 shows the 2 inch steel cap. Numeral 164 shows the steel body of the bell reducer 2×3 inches, 12.2 inches in length. Numeral 165 shows the steel bell reducer port assembly with a 3 inch to 1½ inch tapered diameter, 11.2 inches in length. Numeral 166 shows the rubber stopper, 8 inches in length, 2 inches to 1½ inches tapered in diameter. Numeral 167 shows the steel reverse vacuum plug 13.18 inches in length, tapered to center from 2 inches to 1½ inches in diameter to center, and welded to the interior of the 2 inch steel pipe numeral 170. Numeral 168 shows the 1 inch steel oil inlet port welded to the reverse vacuum plug assembly. Numeral 169 shows the ⅜ inch threaded steel rod, galvanized, 40.58 inches in length. Numeral 170 shows the reverse vacuum plug assembly. Numeral 171 shows the steel handle, 12 inches in length, pivoted to the rod.

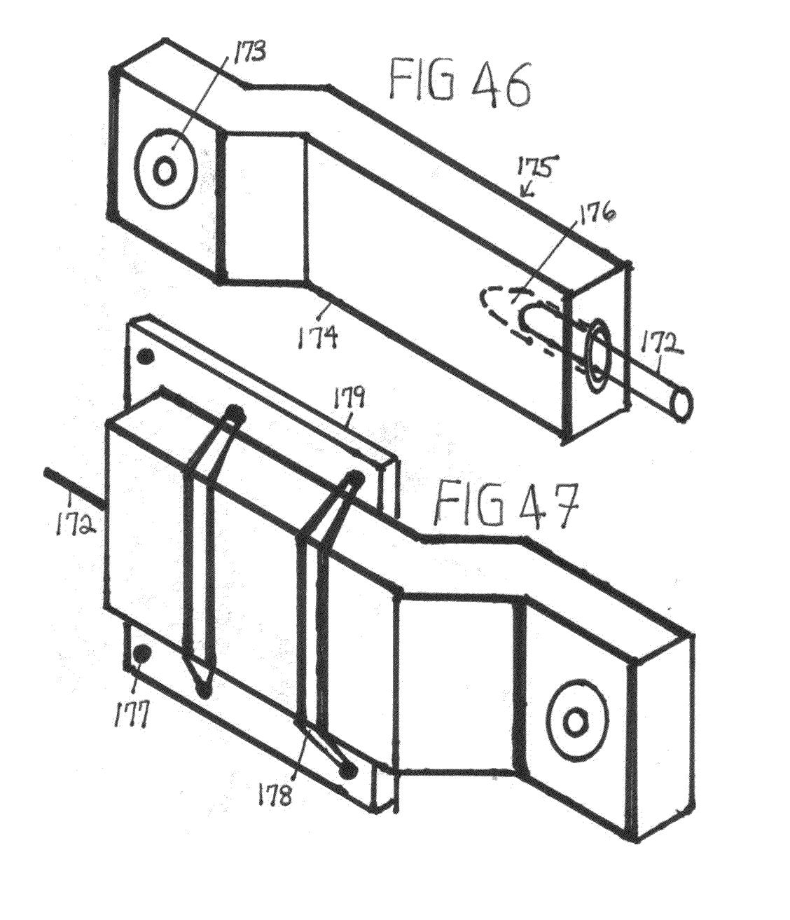

FIG. 46 shows the aluminum static inductor, one for each tank, 14.18 inches in length, and 2.18 inches in width and 1⅜ inches in thickness, machined to 1 inch in thickness and tapered. Numeral 172 shows the #14 copper wire from the static inductor, going to the methane hydrate crystalline tank at 277 volts @1.2 amp and reduces to 12.1 volts @ 1.1 amps, single phase. The static inductor #14 copper wire going to the oil tank is at 27 volts @ zero amps and reduces to 1 volt. Numeral 173 shows the ⅜ inch off set contactor. Numeral 174 shows the aluminum static inductor bar. Numeral 175 shows the complete static inductor. Numeral 176 shows the brass emersion well pressed into the static inductor. FIG. 47, numeral 177 shows the completed static inductor bolted to the polybutylene plate and bolted to the wall. Numeral 178 shows the inductor straps, polybutylene. Numeral 179 shows the plate, polybutylene. Numeral 180 shows the bracket for the polybutylene cooling duct. Numeral 181 shows the ceiling hanger. Numeral 182 shows the ½ inch holes for air circulation and cooling.

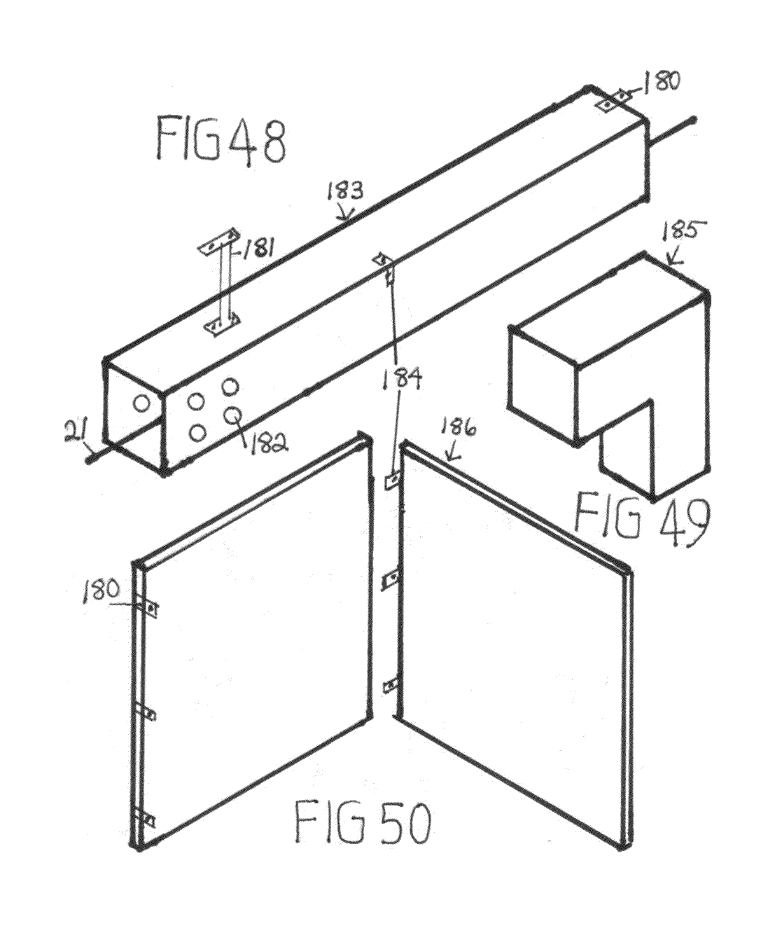

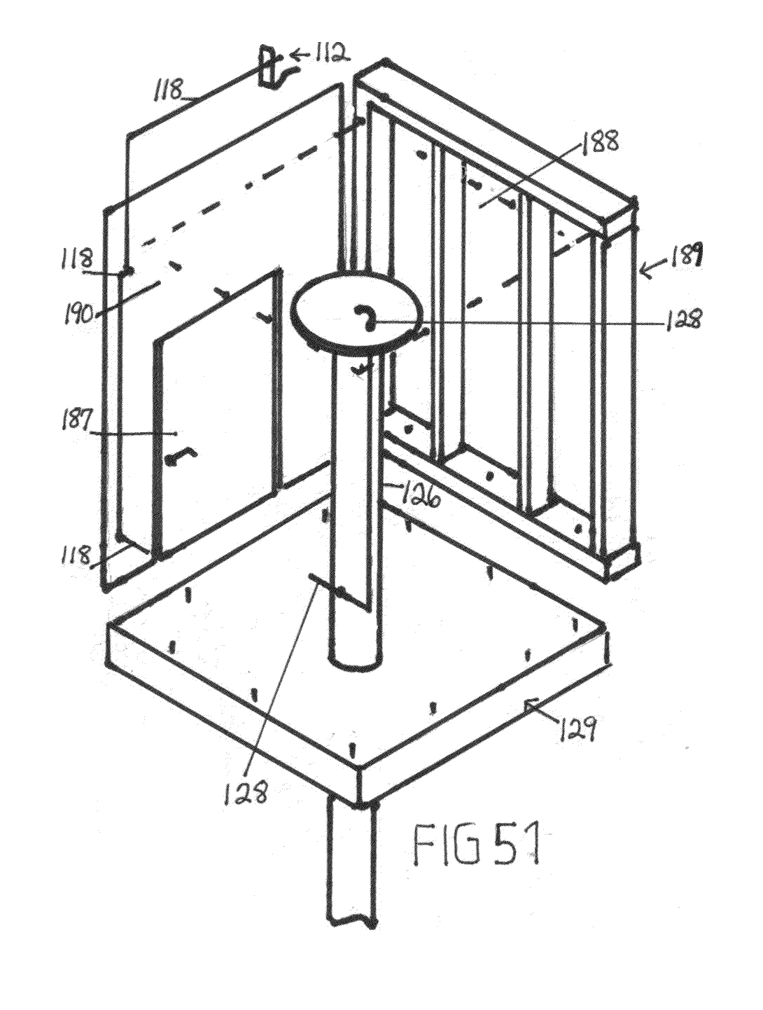

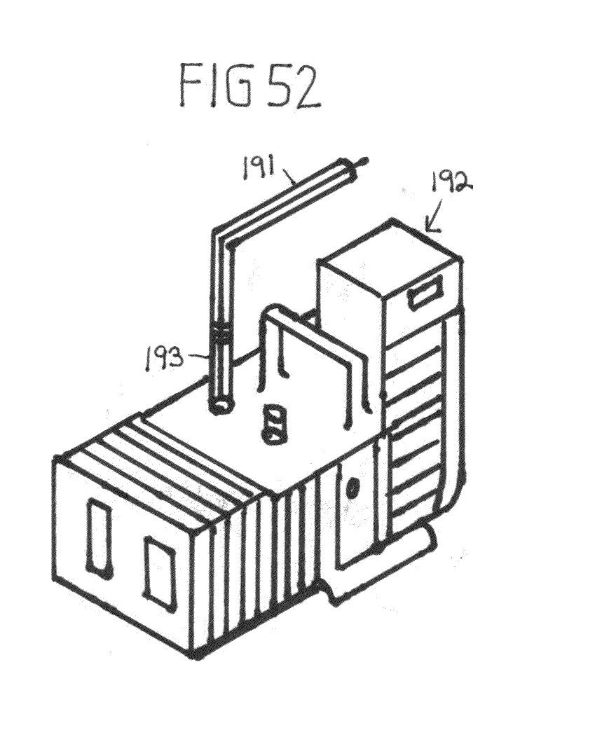

FIG. 48 shows the safety allowances. Numeral 183 shows the polybutylene cooling duct for the inductor rod cut to fit. Numeral 184 shows the polybutylene L bracket. FIG. 49, numeral 185 shows the 90 degree angle. FIG. 50, numeral 186 shows the polybutylene sheets for the casing. FIG. 51 shows the non conductive building surrounding the resonance field driver plate assembly numeral 126. Numeral 187 shows the non conductive door. Numeral 188 shows the polybutylene roof that is mounted at a minimum of 5 feet (important for safety) above the resonance field driver plate assembly. Numeral 189 shows the non conductive 2×4 wall material×4 sides. Numeral 190 shows the polybutylene 4×8 sheets to line the walls and door. FIG. 52 shows the vacuum pumps. Numeral 191 shows the feed through tube and #14 copper cobalt infracted wire. Numeral 192 shows the completed vacuum pump. Numeral 193 shows the vacuum port, size adjustable.

### Specifications and Operations

At a location at least 14.8 miles away from the main power grid, construct building, 60 ft×60 ft, non-conductive or concrete structure with an internal linear room maintained @ 41 degrees F. The floor of the building is constructed of 4 inch thick concrete. The grounding field area on the exterior of the building should have a 760 square foot minimum. The grounding field supporting wall is a minimum of 81 feet in length×12.2 feet in height×8 inches in width, built of concrete to support the grounding field, having a concrete pad of the same size with drainage. In a separate area, a second concrete pad for the resonance field driver assembly, 5 foot square×4 inches thick, no rebar, should be constructed within 31 feet of the linear room (for maximum efficiency), inside or outside of the 60 ft×60 ft building. This location must be a minimum of 300 feet away from any body of water containing greater than 1,984 gallons, or up to a depth of 32 feet.

On center of the resonance field driver assembly concrete pad, drill a 6 inch hole 1,400 feet into the Earth, with a second hole 5 feet away, directly adjacent for easy transition for use after the end of the first 14 year cycle. (The 4 inch driver will show strips on the steel to indicate changing is necessary, change at 14 years due to electrolysis infraction). Install a 4 inch in diameter steel pipe driver into the 6 inch drilled hole for 1,400 feet, end over end, and weld the open ended pipe on the first length, prefabricated in 100 foot lengths, welded together having the joints supported with steel bar which is welded to the outside of the pipe. There are 4 bars per joint, (joint retainer supports) crossing each other perpendicularly which are ¾ inch thick and 22 inches in length as a final support structure for each joint. The driver is terminated at 8 inches above the concrete pad. Riser clamps are installed for support. The 1,400 foot pipe is instilled with concrete (low level rock mesh, approx. 10 cubic yards of concrete) and level with the pad. Concrete is cured in 13.8 days. The resonance field driver is set at this point. (Install 4 inch diameter steel pipe into second 6 inch drilled hole, and instill with concrete for future use after the end of the first 14 year cycle).

Within the constructed 60 ft×60 ft building, a linear room is constructed 18 feet×40 feet. Rough-in the electrical conduit at the appropriate locations at this time, and provide electrical conduits to vacuum pumps at the lithium oxide capacitor location and a dedicated panel for all apature involvements related to the XCL Power Producer exclusively. The room is constructed without rebar in substrate of concrete, with a minimum of a 14 inch thick slab (approx. 30 cubic yards of concrete). The base rock should be tamped at a minimum of 33%. The linear room is enclosed with non conductive materials, and 5 foot wide non conductive door(s) for entry. The XCL Power Producer is assembled within the confines of the linear room over the 4 inch thick concrete slab. Construct 3 adjacent walls 18 ft×40 ft. configuration over the 14 inch thick slab with 8′3″ ceiling, leaving the last wall for construction after the track is installed. Install polybutylene sheeting behind area of tank location and flooring, although not necessary on the ceiling.

Set the oil and methane hydrate crystalline tanks 2⅜ inches from the wall on the 14 inch thick concrete slab in the linear room. Move the prefabricated track retainer assembly on center of room, place on track stands, weld and install bottom portion and level. Install Seismic bracing for casing, install casing and oscillator on top of the seismic bracing leveled to 1 inch above the track retainer. Screw the aluminum bars to the casing and weld to the track retainer on the outside to seal the casing and track retainer. Use an alloy in the interior if required to complete seal, and solder the aluminum and brass.

Machine cut the Samarian cobalt magnets, 4 in×4 in, ½ in thickness, to fit the magneto, approx. 1/16 inch groove, 1.18 inches from the side with the exception of the first magnet, FIG. 35, numeral 109, which is cut at a 45 degree angle until it meets the groove numeral 111. Set the first row of magnets around the track assembly from left to right until they meet the casing on the other side, leaving 1/16 inch allowance for a final interior alloy solder joint all the way around the casing. The magneto wire must not intersect the casing with a set back clearance of 2.18 inches for both sides of the track than encompass the infusers. Fold the magneto wire in half, 84 feet, and set the magneto into the grooved area around the track, and bring the wires to the other side of the track; one side is looped, two sides are open, FIGS. 31 & 32.

Drill and install infuser assemblies, 2 on conductive side, one on inductive side and weld to the track retainer bottom. On the conductive side, tie #14 copper cobalt infracted lead from the induction coupler into the magneto and stub out beyond the track for hook up to the induction coupler numeral 32. Solder a #14 copper wire numeral 30 and stub out beyond the track for tie in to the Tee inversion area. On the inductive side, stub out #14 copper cobalt infracted wire from the infuser numeral 44 and close the open end loop. Solder the ⅜ inch copper cobalt infracted rod into the #14 copper cobalt infracted wire from the infuser, and stub out the ⅜ inch copper cobalt infracted rod long enough, numeral 41, to accommodate the induction coupler and its location.

Return to the side of the casing and install the second row of the Samarian cobalt magnets to where they repel the first row. There are a total of 384 Samarian cobalt magnets, 4 inches×4 inches. Install the aluminum bars by holding the magnets together and spot weld the bars to hold down the second row of magnets, and spot weld the bars to the track retainer. Off-center of each bar, screw each set of magnets together, and remove the center portion of the bars on each row 1.2 inches from the side edge, once they are screwed together. The resistive qualities of these magnets are 451 psi in resistance and will have a tendency to flip, thus adhere to safety precautions. Install prefabricated aluminum track bars to the side retainers and suppress as necessary. Weld the prefabricated photo cell, numeral 87, to the top of the 2 foot vescue over the casing. Install top portion of casing vescue, numeral 100, with installed photo cell and weld to track vescue on each side of the casing, numeral 93, and weld the track bars, numeral 101 to the final assembly and seal the casing to the track vescue with track bars.

Tie in the high induction lead ⅜ inch copper cobalt infracted rod from the oil tank numeral 6 to numeral 27 first Tee inversion area. Install the prefabricated tee inversion assembly, which consists of three resisters soldered together in a T configuration. The branch portion is pointing downward, FIG. 10, and ties into numeral 30 infuser at the track assembly. Stub out numeral 28 outside the linear room to NCD, making sure all high and low inductors are sleeved through the walls.

At the methane hydrate crystalline tank, tie in ⅜ inch copper cobalt infracted rod numeral 38 to numeral 18 infuser assembly, and install prefabricated lithium ore resister assembly in the second tee inversion area on the inductive side, FIG. 12. The down portion of tee inversion area goes to the induction coupler and a future branch tee numeral 37, is installed for the inthesies molecular relief, numeral 42, and terminates at the photo cell aluminum encumber numeral 51.

The dry side of the induction coupler numeral 49 is tied into the infuser numeral 44 via the ⅜ copper cobalt infracted rod numeral 41, that has been stubbed out under the track retainer. A #14 copper cobalt infuser wire numeral 32 ties into the infuser assembly that has been stubbed out on the conductive side, making sure the wire enters the magnets from the corner. From the tee inversion numeral 37, run a #14 18 k gold lead (inthesies lead) numeral 42 to the top of the photo cell assembly (aluminum encumber assembly) and solder to top of pipe without penetration for the inthesies molecular relief. A ⅜ inch copper cobalt infracted rod, numeral 39, is stubbed outside of the linear room and tied into 1 inch stranded copper lead numeral 138 on the inductive side of the lithium oxide capacitor, sleeved as necessary.

On the conductive side of the track, numeral 28, a ⅜ inch copper cobalt infracted rod ties into the NCD FIG. 36, numeral 117. The NCD and box are installed and a ⅜ inch copper cobalt infracted rod continues to the resonance field driver assembly area and stubbed in. Numeral 128, a ⅜ inch copper stranded wire is fed through the resonance field driver plate assembly through holes provided on the plate and pipe, making sure the wire does not touch location numeral 127, the first hole on the resonance field driver assembly. The resonance field driver assembly is then welded to the stub up, and tied into ⅜ inch stranded copper wire, numeral 128, and a ⅜ inch copper cobalt infracted rod numeral 118 to the NCD.

At FIG. 2, oil tank nipple, numeral 3, run a low inductor lead, ⅜ inch copper cobalt infracted rod to the photo cell port, FIG. 16 numeral 56, and (return low inductor lead). At FIG. 7, methane hydrate crystalline tank diffuser numeral 15, run ⅜ inch copper cobalt infracted rod to the photo cell port numeral 57, (supply low inductor lead).

Next, set the prefabricated lithium oxide capacitor FIG. 40 onto concrete pad outside near the transverse oil system. Install the transverse oil piping FIG. 44, fitting to fitting and anchor to concrete wall FIG. 1. Install trisolator FIG. 43 numeral 152 every 4 feet inside the piping. FIG. 41, run 500 feet of ⅜ inch stranded copper wire numeral 144 through the center of the transverse oil system and feed through the piping and trisolator simultaneously during the installation of the piping. The wire must stay on center through all 20 risers, and tie into the last infuser at the end of the system and bell reducer numeral 157. It is then bolted to the grounding plate numeral 158. A cap is welded to the discharge pipe numeral 155, and the last 90 degree angle. Next install a 2 inch×10½ foot pipe numeral 160 to numeral 161 oil inlet, on the main piping. Install the prefabricated reverse vacuum plug assembly FIG. 45 numeral 170 on top of the pipe and weld together. Remove oil inlet port cap, numeral 168, and fill transverse oil system with 1,400 gallons of vegetable oil (preferred), or SAE 30 oil.

At the linear room, install the static inductors, FIGS. 46 & 47, for both tanks and mount on the wall behind the tanks, making sure the contactors on the static inductors make contact with the metal on each tank (creating simulative value).

Hook up the contactor lead 1 inch sheathed stranded copper wire, numeral 141 from the lithium oxide capacitor to the grid. The XCL Power Producer should be located at least 14.8 miles away from the gird, allowing more resistance to be created by allowing the 14.8 miles of lead to be inducted with power for optimum efficiency.

Install polybutylene cooling ducts, FIG. 48, numeral 183, inside the linear room around the 2 high inductor leads, and 2 low inductor leads on the system. Incorporate necessary fittings, FIG. 49 numeral 185. Install polybutylene sheeting around casing, FIG. 50, prior to generating power. Outside the linear room, conduit can be used to house the high inductor that continues to the resonance field driver and lithium oxide capacitor. A minimum size of conduit for the lithium oxide capacitor is 3 inches, with a heat quality that can withstand 400 degrees F.

Construct the non conductive building, FIG. 51, around the resonance field driver assembly, with roof, door, and polybutylene flooring. No insulation should be built into the walls or ceiling.

Tie in numeral 118, the NCD ⅜ inch copper cobalt infracted rod to numeral 128, ⅜ inch stranded copper wire, which completes installation of the conductive side.

Install polybutylene sheets on the concrete pad around the lithium oxide capacitor.

FIG. 52, install vacuum pumps. Hook up vacuum pumps but do not vacuum down. Wire all vacuum pump assemblies to 120 volts, not to exceed 13 amps. Wire static inductors for oil tank@ 27 volts single phase, no amp, and for methane hydrate crystalline tank @ 277 volts single phase, 12.1 amps, making sure the breaker is off, until the system is activated. Hook up casing stator wire numerals 85 & 89, to 480 volts, single phase, 12.18 amps, to the circuit that is provided near casing, with breaker off.

### Vacuum Pump Installations

First Pump: Install feed through lead, numeral 191, between oil tank FIG. 2 and vacuum pump FIG. 52, and solder with coupling into numeral 7.
Second Pump: Install feed through lead, numeral 191, between methane hydrate crystalline tank FIG. 7 and vacuum pump FIG. 52, and solder with coupling into numeral 19.
Third Pump: Install feed through lead, numeral 191, between photo cell FIG. 16 and vacuum pump FIG. 52, and solder with coupling into numeral 58.
Forth Pump: Install feed through lead, numeral 191, between casing FIG. 83 and vacuum pump FIG. 52, and solder with coupling into numeral 86.
Fifth Pump: Install feed through lead, numeral 191, between the transverse oil system FIG. 44 and vacuum pump FIG. 52, and solder with coupling into numeral 154.
Sixth Pump: Install numeral 191 (without feed through) between the transverse side of the lithium Oxide capacitor FIG. 40, numeral 130 and vacuum pump FIG. 52, and solder to brass adaptor into numeral 137.
Seventh Pump: Install numeral 191 (without feed through) between the inductive side of the lithium oxide capacitor FIG. 40, numeral 131 and vacuum pump FIG. 52, and solder to brass adaptor into numeral 142.
Eighth Pump: Install numeral 191 (without feed through), between the 2 foot vescue of the track assembly FIG. 24 and vacuum pump FIG. 52, and solder to brass adaptor into numeral 92.

To initiate power production in the XCL Power Producer System, vacuum down the pumps in this specific order:

First Pump: Turn breaker on for oil tank vacuum pump, and vacuum down to 2.8, with a vacuum time of approx. 31 minutes. Check gauge to condition.
When first pump is completely vacuumed down, initiate static inductor, FIGS. 46, to 27 volts, single phase, zero amp. At the contactor, there is 1.28 volts @ zero amp through the static inductor (voltage delineation factor through static inductor).
Second Pump: Turn breaker on for methane hydrate crystalline tank vacuum pump, and vacuum down to 2.519, with a vacuum time of approx. 39 minutes. Check gauge to condition.
Once the second pump is completely vacuumed down, initiate static inductor FIGS. 46, to 277 volts, single phase, 12.1 amps. At the contactor, there is 12.1 volts @ 1.2 amps through the static inductor (voltage delineation factor through static inductor).
Third Pump: Turn breaker on for photo cell vacuum pump and vacuum down to 2.519, with a vacuum time of approx. 39 minutes. Check gauge to condition.
Forth Pump: Turn breaker on for casing vacuum pump and vacuum down from 2.419 to 2.791, with a vacuum time of approx. 38 minutes. Check gauge to condition.
Fifth Pump: Turn breaker on for transverse oil system vacuum pump and vacuum down to 2.81, with a vacuum time of approx 38 minutes. Check gauge to condition.
Sixth Pump: Turn breaker on for transverse side of the lithium oxide capacitor vacuum pump and vacuum down to 2.791, with a vacuum time of approx 41.8 minutes. Check gauge to condition.
Seventh Pump: Turn breaker on for the inductive side of the lithium oxide capacitor vacuum pump and vacuum down to 2.791, with a vacuum time of approx 41.8 minutes.
Check gauge to condition.
Check grounding plate voltage of 2.81.
Eighth Pump: Turn breaker on for the 2 foot vescue of the track assembly vacuum pump and vacuum down to 2.418, with a vacuum time of approx. 13.8 hours. Check gauge to condition.
After the completion of vacuum time for the eighth pump, terawatt production shall commence. We expect between. 45,000-48,000 volts at start up and gradually reduce to 45,000 volts @ 300 amp, continually for the 14 year cycle.

### Desalination of Seawater Procedures in Resonance Fielding

The XCL Power Producer has the capability of reducing the salinity in seawater from its optimal level down 41%. The gallon capacity is 9,000 gallons in 31 days. It would require a pool of seawater indexed at 13.8 feet from the resonance field driver assembly, with a inlet and outlet for supply and return into a coil that extends vertically for 14.8 feet. The aluminum piping runs horizontal in a loop similar to a condensing coil, with a pump installed on the supply and a pump installed on the return back to the pool. The pool requires an enclosure and an adjacent tank to displace the water from the pool to the tank away from the resonance field driver assembly, approx. 81 feet. While the seawater is resonating, it is not to be touched by human or animal due to the high resonance field effect.

### Important Safety Considerations

1. Never touch the resonance field driver assembly, 4 inch steel pipe, or inductor rods from the resonance field driver assembly numerals 28, 117, 118, & 128 during operation, as it has a negative ionic voltage of 1,397. Also maintain a one foot clearance from these rods. If touched, it will repel you, and will result in the need to be diffused by spraying water on forehead to reduce the negative ionic induction of that individual.
2. A person must maintain a 5 foot clearance above the resonance field driver plate as the plate is emitting 1,397 negative ionic volts.
3. Never touch the high induction ⅜ inch copper cobalt infracted rod from the methane hydrate crystalline tank through the tee inversion area on the high induction side to the Lithium oxide capacitor as it is high voltage @ 45,000 volts 300 amps and will result in fatality.
4. Never touch the vacuum leads on the lithium oxide capacitor, numerals 137 & 142, during the course of operation. These leads are highly inductive and conductive. This is generating 4,800 volts A/C @ 281 amps and a negative ionic impulse every 22 seconds with 322 additional ionic volts zero amp.

### Test Procedures

Oil tank: inductor lead (diffuser) going to the photo cell is generating 14 volts A/C; low inductor lead (infuser) going to the resonance field driver assembly is generating 1,397 negative ionic volts after the second resistor.

Methane hydrate crystalline tank: high inductor leads are generating 41,202 volts A/C @ 281 amps.

Grounding plate location: inductor lead generating 2.81 volts A/C, zero amp.

Transverse side of lithium oxide capacitor: great care should be taken at this point, this is high voltage, the leads coming from the vacuum pump are also high voltage, test for 4,800 volts A/C @ 281 amp with a negative ionic impulse every 22 seconds, with 322 additional negative ionic volts no amp.

Inductive side of lithium oxide capacitor: great care should be taken at this point, this is high voltage, and the leads coming from the vacuum pump are also high voltage, test 4,800 volts A/C @ 281 amps, variable is within two tenths.

The outlay voltage to the grid, at this point, is 48,381 volts A/C @ 309 amps, and delineates to 45,391 volts @ 301 amps in 14 miles. The XCL Power Producer System will run continually for 14 years, unless there is a breach in the system. Vacuum pressures and voltage outlay should be monitored during the course of the 14 year period.

Desalination Test Procedures: All testing for desalination is conducted 81 feet from the resonance driver assembly at tank distribution area. All pumps and apparatus are piped to a staging area and further treatments are conducted for distribution of potable water.

Procedure for permanent shut-down or change-over for next 14 year cycle:
1. Shut off circuit breaker to whole building.
2. Check casing to make sure power is not being drawn from the main breaker into the casing. Under vacuum it is possible to pull electricity from the panel even though it is off. Make sure there is no power, zero voltage and zero amp, to the casing.
3. Pull diffuser from the NCD and check the lead going to the diffuser. There should only be 14 volts or less coming from the ⅜ inch copper cobalt infracted rod numeral 28 feeding the resonance field driver assembly. On the opposite side of the NCD, check ⅜ inch copper cobalt infracted rod, numeral 118, which should only be 14 volts or less, zero amp. If there is more than 14 volts, the system will have to sit for at least 24 hours or until there are no more than 14 volts, zero amp. The diffuser should remain disconnected during the course of the shut down and change over.
At this point, the XCL Power Producer system may be shut down permanently. When the diffuser is pulled, the result is a drop in voltage and amperage, which is 341 volts @ 38 amps, and will delineate to zero within 38 days.
4. Check the resonance frequency, which should be 0.0001 in resonance hex joule displacement. Once resonance hex joule displacement is 0.0001 or less, disconnect the resonance field driver lead, ⅜ inch stranded copper wire, numeral 128.
5. Cut and remove resonance field driver assembly and reinstall and weld at future site previously provided 5 feet from original site. Reconnect ⅜ inch copper cobalt infracted rod and ⅜ inch resonance stranded copper wire at the new location.
6. Install new oil tank, previously prepared. Recycle first tank for future use. Disconnect vacuum pump lead numeral 7, infuser lead numeral 6, and diffuser lead numeral 3. Reconnect to leads on new tank, 14 inches away from tank. Install and secure new tank in linear room.
7. Install new methane hydrate crystalline tank, previously prepared. Recycle first tank for future use. Disconnect vacuum pump lead numeral 19, infuser lead numeral 18, and diffuser lead numeral 15. Reconnect to leads on new tank, 14 inches away from tank. Install and secure new tank in linear room.
8. Reinstall NCD, FIG. 37, into NCD box, FIG. 36, making sure the connection is close coupled at the ⅜ inch copper cobalt infracted rods, numeral 114 connects to 118, and 117 connects to 124, making sure the rods make contact.
9. At the resonance field driver plate assembly where ⅜ inch stranded copper wire, numeral 128 exits, make sure the current voltage is at 14 or less with zero amps.
10. Turn main circuit breaker on.
11. Check vacuum pump pressures.
12. See vacuum pump installations and vacuum down pumps. System is operational at this point for 14 year cycle.

### Permanent Shut Down

See steps 1-4 of change over. Check NCD voltage, making sure inductor lead numeral 117 is at 341 volts @ 38 amps or less. Leave for 38 days for power to delineate to zero volts zero amp.

1. A method for the production of electricity of 45,000 volts @ 300 amps.

2. A method for the production of a resonance field driver assembly producing 1.1 hex joules.

3. A method set forth in claim 2 further comprising 1,397 negatively charged ions.

4. A method set forth in claim 2 further comprising that corona mass ejections are repelled by the resonance field driver assembly.

5. A method set forth in claim 2 further comprising the deflection of lightening strikes by the resonance field driver assembly.

6. A method set forth in claim 2 further comprising radioactive particulates are driven from our environment reducing radiation pressure.

7. A method set forth in claim 2 further comprising of a repelling magnetic field of energy balanced from the lithium oxide capacitor to the resonance field driver assembly, further strengthening the ozone with a total incumbency of 1,481 units.

8. A method set forth in claim 2 further comprising of the desalination of seawater.

9. A method for the production of aluminum photo cell, total length of 28.768 inches.

10. A method set forth in claim 9 further comprising of the production of 60 hertz continually.

11. A method set forth in claim 9 further comprising of diffuser port.

12. A method set forth in claim 9 further comprising of infuser port.

13. A method set forth in claim 9 further comprising of vacuum pump port.

14. A method set forth in claim 9 further comprising of a vacuum pressure of 2.791.

15. A method set forth in claim 9 further comprising of a glass internal vescue, total length of 9.418 inches.

16. A method set forth in claim 15 further comprising of an internal vescue of 3.419 inches in diameter.

17. A method set forth in claim 16 further comprising of an external vescue of 4.169 inches in diameter.
